(19) United States
(12) Patent Application Publication
(10) Pub. No.: US 2026/0203273 A1
(43) Pub. Date: Jul. 16, 2026

(54) SYSTEMS AND METHODS FOR UPDATING FACT OBJECTS FOLLOWING A DEPOSITION EVENT

(71) Applicant: RELATIVITY ODA LLC, Chicago, IL (US)

(72) Inventors: Nathan Reff, Rochester, NY (US); Aron Ahmadia, Arlington, VA (US); Somya Anand, Vancouver (CA); Thilini Cooray, Coquitlam (CA); Grace Shao, Chicago, IL (US)

(21) Appl. No.: 19/448,898

(22) Filed: Jan. 14, 2026

Related U.S. Application Data
(60) Provisional application No. 63/804,128, filed on May 12, 2025.
(60) Provisional application No. 63/804,112, filed on May 12, 2025.
(60) Provisional application No. 63/804,105, filed on May 12, 2025.
(60) Provisional application No. 63/745,512, filed on Jan. 15, 2025.

(51) Int. Cl. G06Q 50/18; G06F 16/23; G06F 16/3329

(52) U.S. Cl. CPC G06Q 50/18; G06F 16/235; G06F 16/33295

(57) ABSTRACT

A system may receive deposition data relating to one or more completed deposition events. The deposition data includes one or more of transcript data and image data. The system may obtain a set of updatable fact objects based on the deposition data and a fact update prompt. The fact update prompt controls how a fact updating machine learning model (i) identifies target objects from the set of updatable fact objects and (ii) extracts or summarizes the deposition data to generate updates to the target objects. The system inputs, into the fact updating machine learning model, the fact update prompt, at least a portion of the deposition data, and at least a portion of the set of updatable fact objects to generate the updates. The system updates the target objects as stored in a data store in accordance with the generated updates.

### CROSS-REFERENCE TO RELATED APPLICATIONS

This application claims priority to (1) U.S. Patent Application No. 63/804,105, entitled “SYSTEMS AND METHODS FOR SIMULATING A DEPOSITION TO IDENTIFY OBJECTS TO PRE-LOAD INTO A CACHE OF A CLIENT DEVICE” (filed May 12, 2025); (2) U.S. Patent Application No. 63/804,112, entitled “SYSTEMS AND METHODS FOR REAL-TIME ANALYSIS AND RESPONSE GENERATION TO DEPOSITION DATA AND A DEPOSITION PLAN” (filed May 12, 2025); (3) U.S. Patent Application No. 63/804,128, entitled “SYSTEMS AND METHODS FOR UPDATING FACT OBJECTS FOLLOWING A DEPOSITION EVENT” (filed May 12, 2025); and (4) U.S. Patent Application No. 63/745,512, entitled “SYSTEMS AND METHODS FOR REAL-TIME ANALYSIS AND RESPONSE GENERATION TO DEPOSITION DATA” (filed January 15, 2025), the entire contents of each of which are hereby incorporated by reference.

### FIELD

The present disclosure generally relates to computer systems for processing, managing, and data related to an interview, deposition, etc. and, more particularly, to systems and methods for updating fact objects following a deposition event.

### BACKGROUND

Electronic analysis and assistance tools are important systems for identifying useful material from large otherwise unwieldy sets of electronic documents and data objects. In particular, the extreme increase in document generation produced by the advent and widespread adoption of electronic devices (computers, smart phones, tablets, etc.) and electronic software tools (email, digital chat, word processing, etc.) has made prior document review and analysis impractical. In particular, the large increase in electronic documents has made witness questioning and fact verification in relation to such documents problematic. In particular, fact verification and confirmation of witness deposition testimony relative to known record evidence is verified based on the particular memory of the questioning attorney, through after the fact review of deposition transcripts, or real-time manual review of deposition transcript data using conventional document management system. As a result, the conventional tools are unable to quickly and productively identify supportive or contradictory documents for witness statements in a real-time manner that may dictate the future course of an in-process deposition.

Additionally, operating machine learning models on a local client device during a deposition event to perform analysis of electronic documents relative to the witness or other individual testimony has proven difficult. In particular, local client devices typically have more limited storage space and processing resources as compared with remotely accessible cloud server systems. For example, the limited storage space typically results in a local client device being unable to consider the total universe of possible documents when analyzing deposition data during a live deposition event. Existing systems lack methods for accurately preselecting the documents most likely to be referenced during a deposition event. Furthermore, the comparatively reduced processing resources on the local client device typically mean that any locally executed models also have comparatively fewer parameter values and context windows to use when analyzing deposition data locally, which can make tracking progress of the deposition event relative to a specific plan or outline difficult. Further still, the limited processing resources and lack of access to the full universe of electronic documents makes it difficult to properly and completely update fact objects related to the deposition event locally on the client device.

Accordingly, there is a need for systems and methods that can automatically analyze and process a real-time feed of deposition data to identify supportive or contradictory documents or related data objects, which can then be utilized to generate recommended response options for attorneys in a quicker and more accurate manner than possible using currently existing tools. Furthermore, there is a need for improved systems and methods that identify workspace objects to preload onto a cache of a client device, utilize and track a deposition plan when analyzing deposition data with a machine learning model, and update fact objects following completion of a deposition event.

### SUMMARY

In some aspects, the techniques described herein relate to a computer system including: one or more processors; and one or more non-transitory, computer-readable media storing instructions that, when executed by the one or more processors, cause the computer system to: receive deposition data relating to one or more completed deposition events, wherein the deposition data includes one or more of transcript data and image data; obtain a set of updatable fact objects based on the deposition data; obtain a fact update prompt, wherein the fact update prompt is configured to control how a fact updating machine learning model (i) identifies target objects from the set of updatable fact objects for updating and (ii) extracts or summarizes the deposition data to generate updates to the target objects; input, into the fact updating machine learning model, the fact update prompt, at least a portion of the deposition data, and at least a portion of the set of updatable fact objects to generate the updates to the target objects; and update the target objects as stored in a data store in accordance with the generated updates.

In some aspects, the techniques described herein relate to a computer-implemented method for generating updates for fact objects, the method including: receiving, by one or more processors, deposition data relating to one or more completed deposition events, wherein the deposition data includes one or more of transcript data and image data; obtaining, by the one or more processors, a set of updatable fact objects based on the deposition data; obtaining, by the one or more processors, a fact update prompt, wherein the fact update prompt is configured to control how a fact updating machine learning model (i) identifies target objects from the set of updatable fact objects for updating and (ii) extracts or summarizes the deposition data to generate updates to the target objects; inputting, by the one or more processors and into the fact updating machine learning model, the fact update prompt, at least a portion of the deposition data, and at least a portion of the set of updatable fact objects to generate the updates to the target objects; and updating, by the one or more processors, the target objects as stored in a data store in accordance with the generated updates.

In some aspects, the techniques described herein relate to a non-transitory machine-readable medium including a plurality of machine-readable instructions that when executed by one or more processors are adapted to cause the one or more processors to: receive deposition data relating to one or more completed deposition events, wherein the deposition data includes one or more of transcript data and image data; obtain a set of updatable fact objects based on the deposition data; obtain a fact update prompt, wherein the fact update prompt is configured to control how a fact updating machine learning model (i) identifies target objects from the set of updatable fact objects for updating and (ii) extracts or summarizes the deposition data to generate updates to the target objects; input, into the fact updating machine learning model, the fact update prompt, at least a portion of the deposition data, and at least a portion of the set of updatable fact objects to generate the updates to the target objects; and update the target objects as stored in a data store in accordance with the generated updates.

### BRIEF DESCRIPTION OF THE DRAWINGS

FIGS. 1A-1D are block diagrams of example computing environments in accordance with one or more embodiments.

FIGS. 2A-2K show example user interface display screens for displaying responses generated using modules of the computing environments of FIGS. 1A-1D.

FIG. 3 is a flow diagram of a method in accordance with one or more embodiments.

FIG. 4 is a block diagram of another example computing environment in accordance with one or more embodiments.

FIGS. 5A and 5B are flow diagrams of methods for generating a synthetic deposition transcript in accordance with one or more embodiments.

FIG. 6 is a flow diagram of a method in accordance with one or more embodiments.

FIG. 7A is block diagram of another example computing environment in accordance with one or more embodiments.

FIG. 7B is a sequence diagram of an example process for generating a response to deposition data using the computing environment of FIG. 7A in accordance with one or more embodiments.

FIG. 8 is a flow diagram of a method in accordance with one or more embodiments.

FIG. 9A is a block diagram of another example computing environment in accordance with one or more embodiments.

FIG. 9B is a sequence diagram of an example process for generating updates for fact objects using the computing environment of FIG. 9A in accordance with one or more embodiments.

FIG. 10 is a flow diagram of a method in accordance with one or more embodiments.

Examples of the present disclosure and their advantages are best understood by referring to the detailed description that follows. It should be appreciated that like reference numerals are used to identify like elements illustrated in one or more of the figures, wherein showings therein are for purposes of illustrating examples of the present disclosure and not for purposes of limiting the same.

### DETAILED DESCRIPTION

The systems and methods described herein relate to new systems and methods for processing and analyzing a real-time feed of deposition data. In particular, the systems and methods described herein describe systems and methods for identifying relevant workspace objects such as portions of saved electronic documents, fact objects, etc. that are relevant to analyzing and processing the deposition data to generate a recommended response. In particular, the response is generated as an output of a deposition analysis machine learning model that includes the relevant workspace objects, a deposition analysis prompt, and the deposition data as inputs thereto.

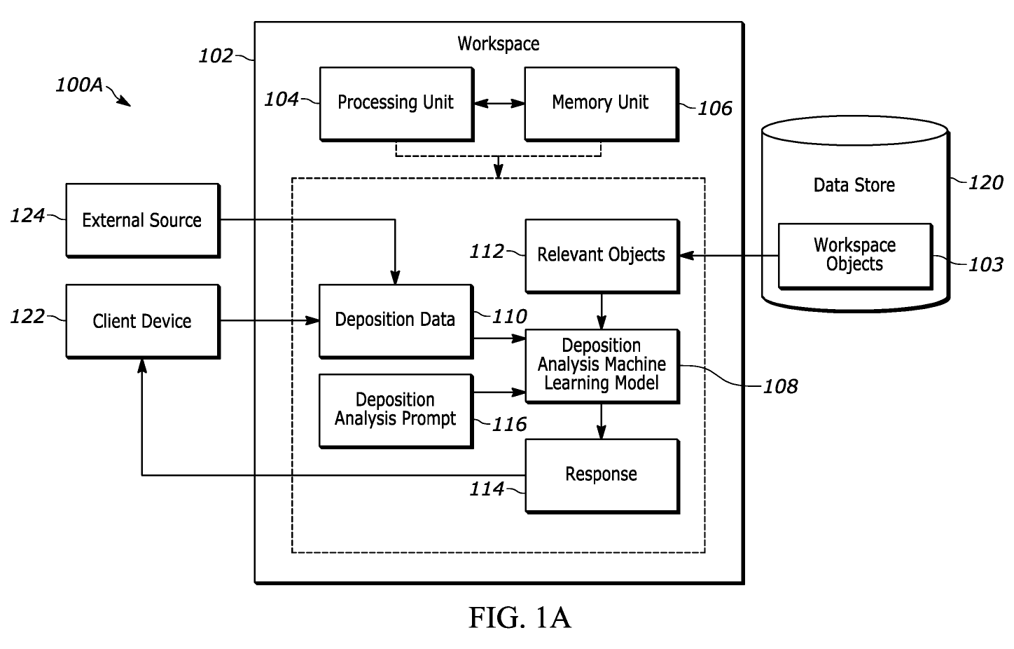

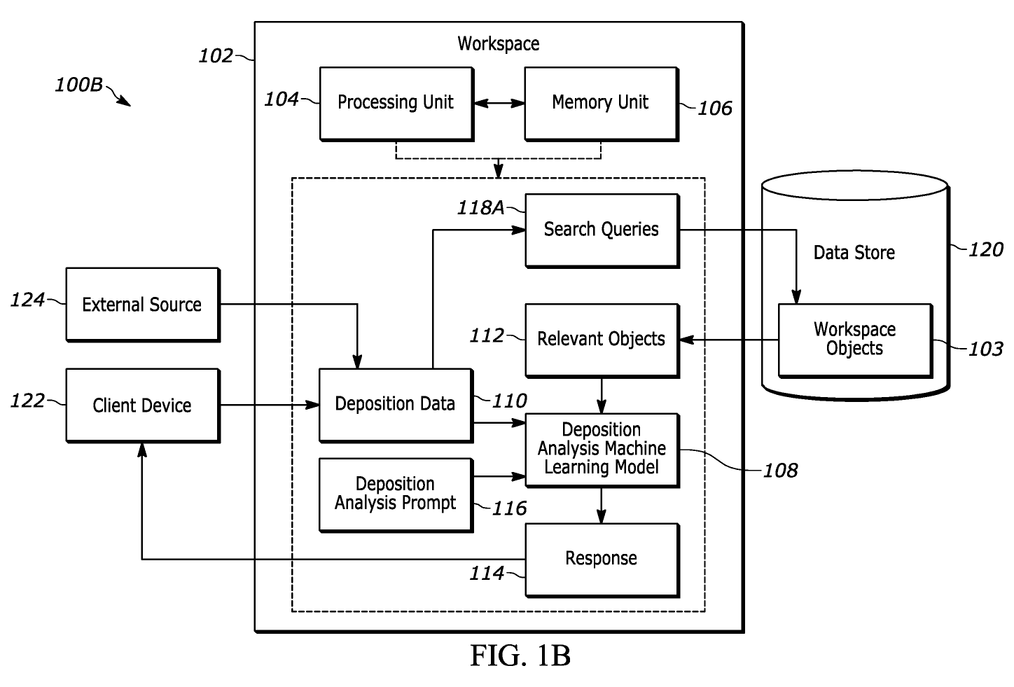

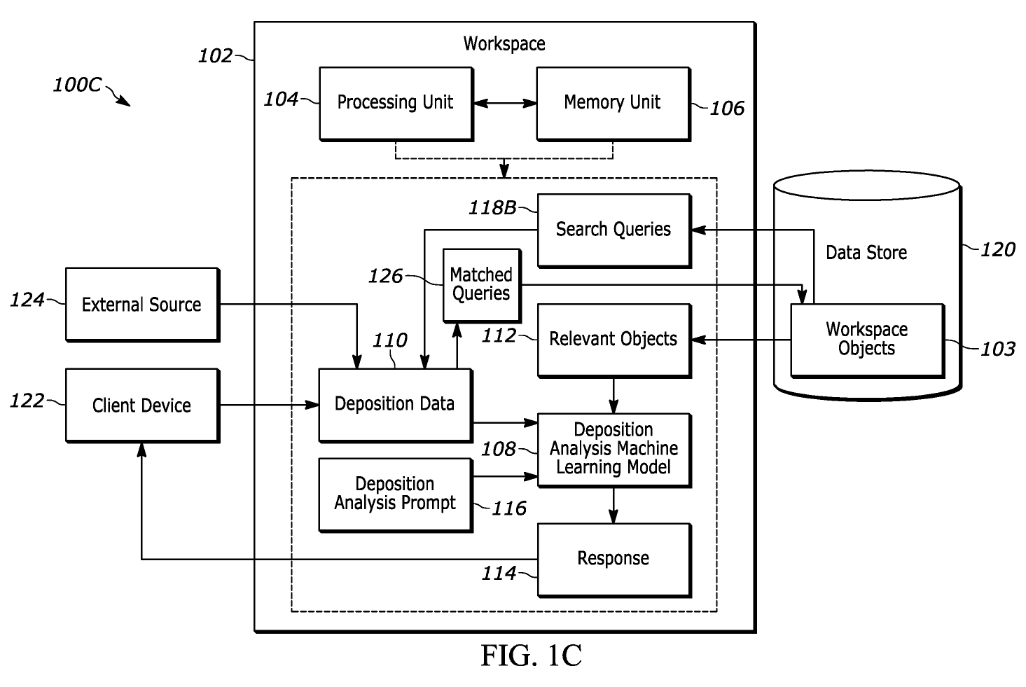

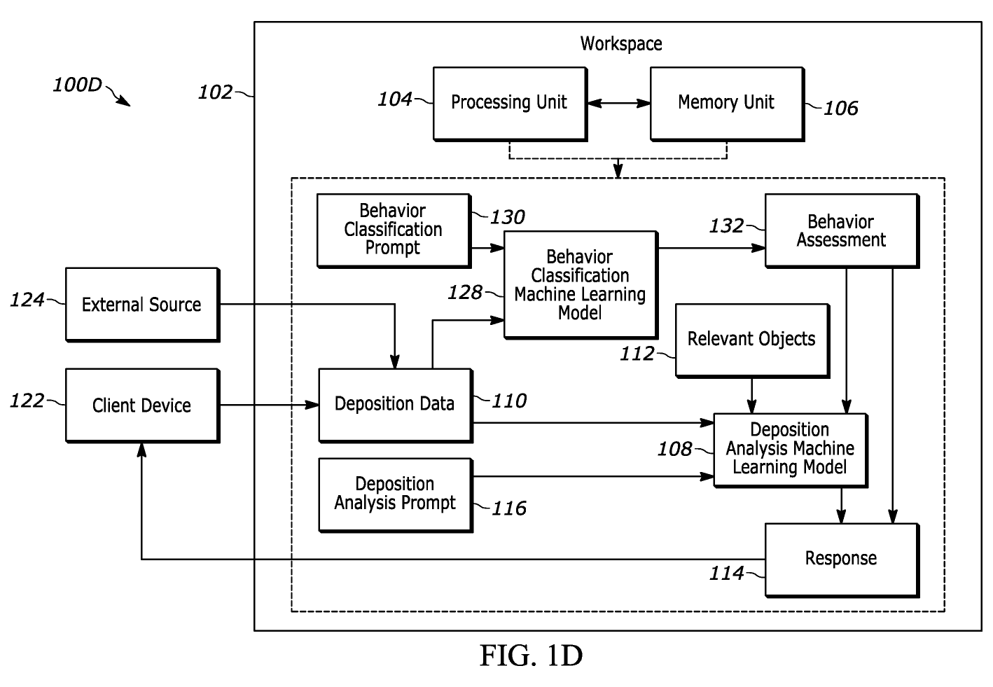

With reference now to FIG. 1A, a computing environment 100A for generating responses that are responsive to deposition data is shown. The computing environment 100A includes a workspace 102. The workspace 102 may be associated with workspace objects 103. The workspace objects 103 may include a corpus of documents such as a set of documents associated with an eDiscovery project and other data objects that are generated from analysis of the corpus of documents such as fact objects, matter issue details, relevant people or entity objects, etc. Documents in the corpus of documents may be in various types of files (e.g., an email file, a word processing file, a spreadsheet file, an audio recording file, imagery data file (e.g., image and/or video data), a text message or other group communication file, etc. Additional detail on the generated data objects are shown and described in U.S. Provisional application 63/719,260 filed November 12, 2024, which is incorporated by reference herein in its entirety.

The workspace 102 and/or the components thereof may be implemented as software or hardware modules within a cloud and/or distributed computing system (e.g., Amazon Web Services (AWS) or Microsoft Azure). Accordingly, the components of the workspace 102 may include separate logical addresses via which the components are accessible via a bus or other messaging channel supported by the cloud computing system. In some embodiments, the workspace 102 includes multiple instances of the same component to increase the ability the parallelization for the various functions performed via the respective components.

A processing unit 104 and a memory unit 106 may implement the computing environment 100A and the workspace 102. More particularly, the processing unit 104 and the memory unit 106 may comprise portions of cloud and/or distributed computing system that implements the workspace 102. Processing unit 104 includes one or more processors, each of which may be a programmable microprocessor that executes software instructions stored in memory unit 106 to execute some or all of the functions of workspace 102 as described herein. Processing unit 104 may include one or more graphics processing units (GPUs) and/or one or more central processing units (CPUs), for example. Alternatively, or in addition, one or more processors in processing unit 104 may be other types of processors (e.g., application-specific integrated circuits (ASICs), field-programmable gate arrays (FPGAs), etc.), and some of the functionality of workspace 102 as described herein may instead be implemented in hardware. Memory unit 106 may include one or more volatile and/or non-volatile memories or similar computer readable media. Any suitable memory type or types may be included in memory unit 106, such as read-only memory (ROM) and/or random-access memory (RAM), flash memory, a solid-state drive (SSD), a hard disk drive (HDD), and so on. Collectively, memory unit 106 may store one or more software applications, the data received/used by those applications, and the data output/generated by those applications.

In particular, memory unit 106 stores the software that, when executed by processing unit 104, performs various functions of the computing environment 100A related to execution of a deposition analysis machine learning (ML) model 108 to analyze deposition data 110 and relevant objects 112 to generate a response 114 to the deposition data 110 as directed by a deposition analysis prompt 116.

As shown in FIG. 1A, the workspace objects 103 are accessible via the workspace 102. The workspace objects 103 may include a set of electronic documents (digitized paper documents, electronically generated documents, documents exported from user devices, etc.) that have been ingested into the workspace 102 and other data objects (e.g., fact objects, matter issue details, relevant people or entity objects, etc.) that have been generated from analysis of the electronic documents or created by user interaction with the workspace 102. In some embodiments, the workspace objects 103 relate to a matter being processed, managed, or analyzed by the computing environment 100A (e.g., a litigation, a discovery request, a research project, etc.). Initially, the processing unit 104 ingests each document in the corpus of documents such that they are accessible by the workspace 102. This ingestion pipeline includes the processing unit 104 assigning each document a unique identifier and performing other pre-processing tasks such as performing optical character recognition (OCR), metadata extraction or processing, etc.

In the illustrated embodiment, the processing unit 104 maintains the workspace objects 103 at a data store 120. The data store 120 may be implemented as a database, data lake, memory, or other digital storage medium known in the art. Accordingly, the data store 120 may be a file system data store, an object-based data store, or other type of data store utilized in the art. Depending on the embodiment, the data store 120 may be implemented locally at the workspace 102, externally at an external data storage service, or a combination thereof. The workspace 102, via the processing unit 104, may be in wired or wireless communication with the external data storage service. In some embodiments, the processing unit 104 may load the workspace objects 103 into a local cache for processing by one or more applications executing in the workspace 102 (such as the deposition analysis ML model 108).

In general, the deposition data 110 includes one or more of transcript data and image data. The transcript data may include one or more of transcribed text from the deposition event, and audio of the deposition event, and the image data may include real-time video of the deposition event. Where the deposition data 110 includes the audio or video data, the processing unit 104 may be configured to convert the data into a text or other data format that is ingestible by the deposition analysis ML model 108. In particular, the deposition data 110 may include question portions that correspond to questions asked by an attorney or other questioner, answer portions that correspond to answers given by a witness or deponent in response to the asked questions, and additional data portions that correspond to other aspects of the deposition event such as objections from a deposition defending counsel.

As illustrated, the deposition data 110 is received in a sequential and real-time manner from a client device 122 or other external source 124. The client device 122 may include a personal user device (mobile phone, computer, tablet, etc.) that is operatively coupled to the workspace 102 via wired or wireless means known in the art. The client device 122 may execute an application (e.g., a browser or a dedicated application) via which the client device 122 interfaces with the workspace 102. The external source 124 may comprise a third party service or system that provides real-time transcripts, audio, video, etc. of the deposition event as a service operated by a court system or transcription vendor. The processing unit 104 may be configured to enroll with the external source 124 to receive the deposition data 110 from the external source 124 as pushed and/or streamed data.

In some embodiments, the processing unit 104 processes the deposition data 110 as it is received to identify segmented text blocks that are input into the deposition analysis ML model 108. To identify the segmented text blocks, the processing unit 104 may identify segmentation markers present in the deposition data 110 as the deposition data 110 is received by the processing unit 104. Then, the processing unit 104 may select portions of the deposition data 110 between identified segmentation markers as the segmented text blocks. The segmentation markers may include a change in speaker such as a change from a questioning attorney to witness, deponent, or deposition defending council or vice versa. In some embodiments, the processing unit 104 may determine the role of each speaker to assist in how the deposition analysis ML model 108 processes the associated segmented text blocks of the deposition data 110. For example, segmented text block associated with a questioner role may be identified as question portion of the deposition data 110 and segmented text block associated with a witness or deponent may be identified as answer portions of the deposition data 110. It should be appreciated that in some embodiments, multiple segments are included in the deposition data 110 analyzed by the deposition analysis ML model 108 to provide additional context (e.g., a question and answer, a prior question and answer referenced by or related to a current segment, etc.).

In some embodiments, the segmentation markers may include a time pause in receipt of new portions of the deposition data 110 that exceeds a preconfigured threshold. In these embodiments, the processing unit 104 may divide up longer portions of the deposition data 110 from the same speaker that are separated by an identified time pause into separate segmented text blocks so that the deposition analysis ML model 108 may begin to process the first segment of these longer potions.

The relevant objects 112 may include a subset of the workspace objects 103 that may be identified as being possibly relevant to the deposition event. In some embodiments, the relevant objects 112 may be compiled prior to the deposition event based on details of the event such as the individual being deposed or questioned. As described in more detail below in connection with FIGS. 1B and 1C, the relevant objects 112 may be dynamically selected during the deposition event based on analysis of the deposition data 110. In some embodiments, the relevant objects 112 may include links to locations in the data store 120 where the underlying object is located.

The deposition analysis ML model 108 may analyze the deposition data 110 and the relevant objects 112 as directed by the deposition analysis prompt 116 to generate the response 114. The deposition analysis ML model 108 comprises a set of interconnected nodes, layers, trained parameter values (e.g., multiplicative weights, additive bias, etc.), etc. The trained parameters are set via backpropagation or other similar techniques in a training process that uses historical data inputs to identify or recognize patterns and trends therein. Various architectures for the deposition analysis ML model 108 are possible, including, but not limited to, convolutional neural network (CNN) architectures, transformer architectures, recurrent/recursive neural network (RNN) architectures, sorting/clustering architectures, etc. In some embodiments, the deposition analysis ML model 108 includes a large language model (LLM). The LLM can be a base model trained by a third party and accessed by the workspace 102 via an application programming interface (API). The LLM can also be a fine-tuned public model (e.g., a model that is initially trained on publicly available or third-party data and tuned using private/proprietary data accessible by the workspace 102) or a full privately trained model managed by the workspace 102 (e.g., a model that is fully trained by the workspace 102 on private/proprietary data and/public data accessible thereto).

The processing unit 104 may input the relevant objects 112, the deposition data 110, and the deposition analysis prompt 116 into the deposition analysis ML model 108. The relevant objects 112, the deposition data 110, and the deposition analysis prompt 116 may be a single set of inputs simultaneously input into the deposition analysis ML model 108 or a sequenced set of inputs sequentially input into the deposition analysis ML model 108. For example, the processing unit 104 may combine the deposition data 110 and the relevant objects 112 with the deposition analysis prompt 116 by appending the raw text of the deposition data 110 and relevant objects 112 together with the deposition analysis prompt 116 or by appending a reference marker for the relevant objects 112 to the deposition analysis prompt 116 that the deposition analysis ML model 108 may use to recall the relevant objects 112 from the data store 120 or the local cache.

The deposition analysis prompt 116 is configured to control how the deposition analysis ML model 108 analyzes content of the deposition data 110 and the relevant objects 112 to generate the response 114. For example, the deposition analysis prompt 116 may include question generating rules that direct the deposition analysis machine learning model 108 to identify supportive or contradictory elements of the relevant objects 112 that support or contradict the deposition data 110 by comparing the deposition data 110 to the relevant objects 112. The questions generating rules may also direct the deposition analysis ML model 108 to generate follow up questions based on the supportive or contradictory elements and include the follow up questions in the response 114. In some embodiments, the supportive or contradictory objects may include electronic documents that support or contradict the deposition data 110. In these embodiments, the deposition analysis prompt 116 may instruct the deposition analysis ML model 108 to include identifiers of the supportive or contradictory documents in the response 114. The processing unit 104 may be configured to present at least a portion of the supportive or contradictory documents on a graphical user interface with the response 114.

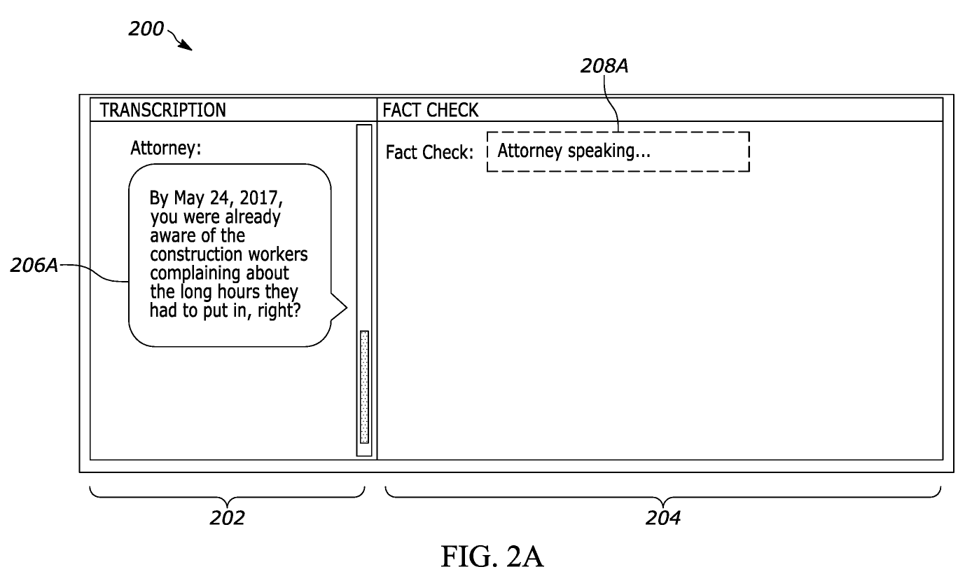

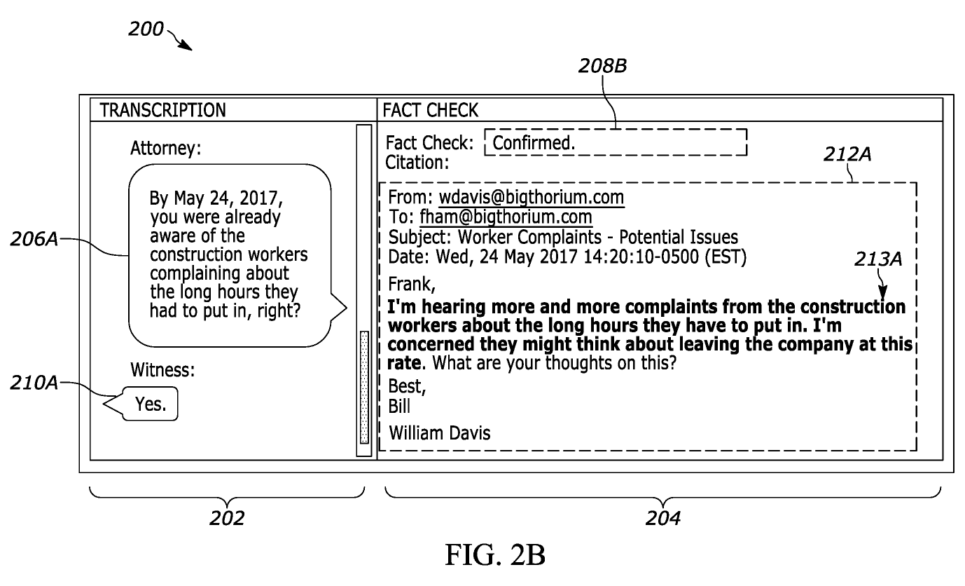

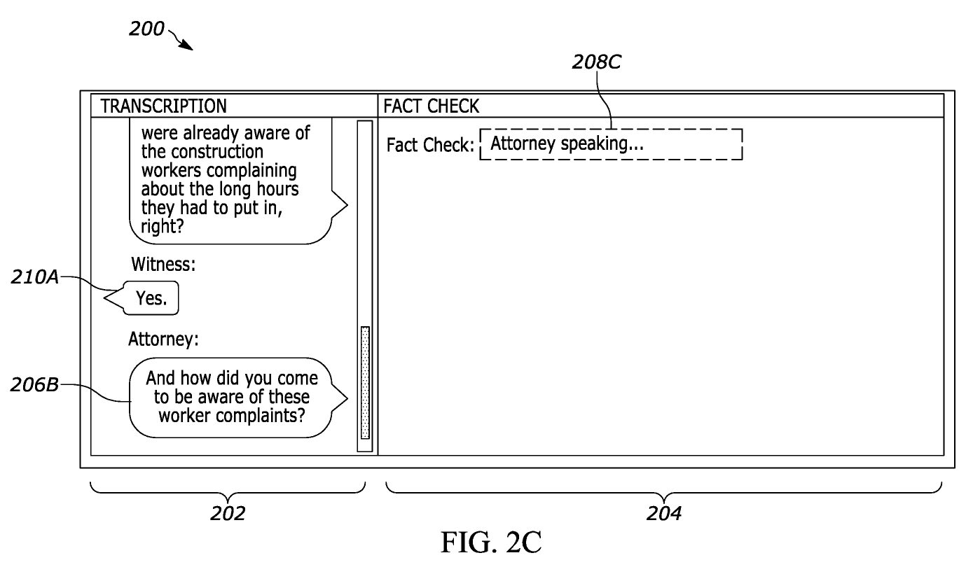

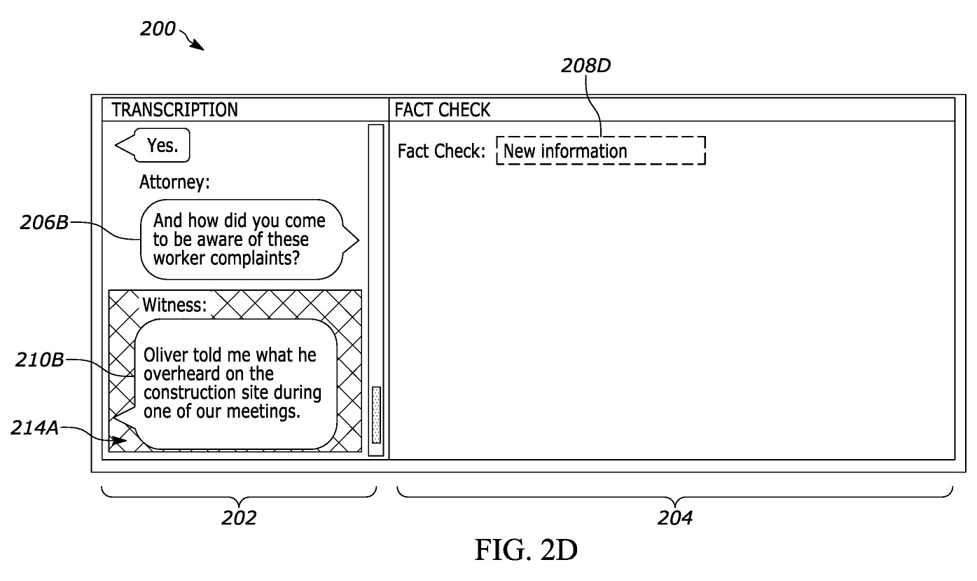

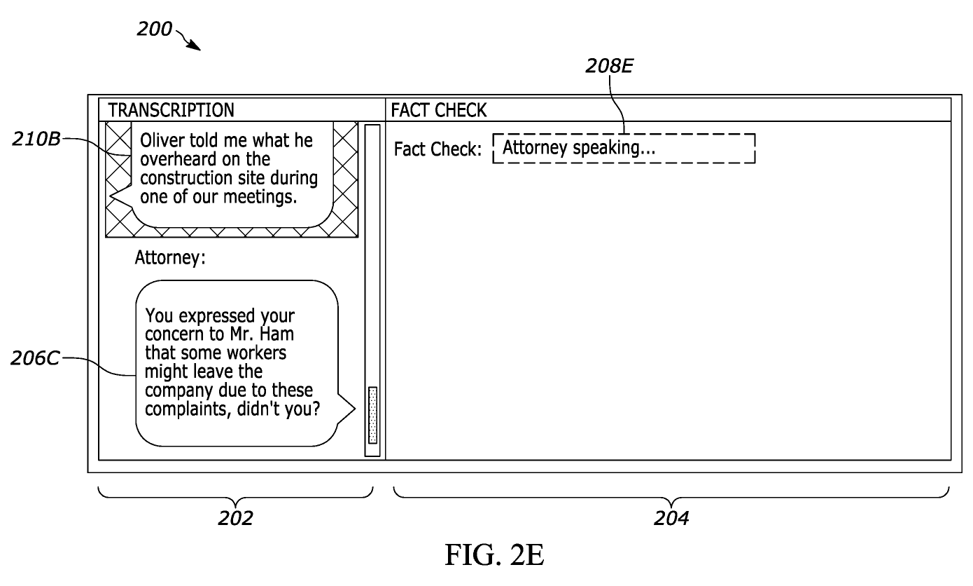

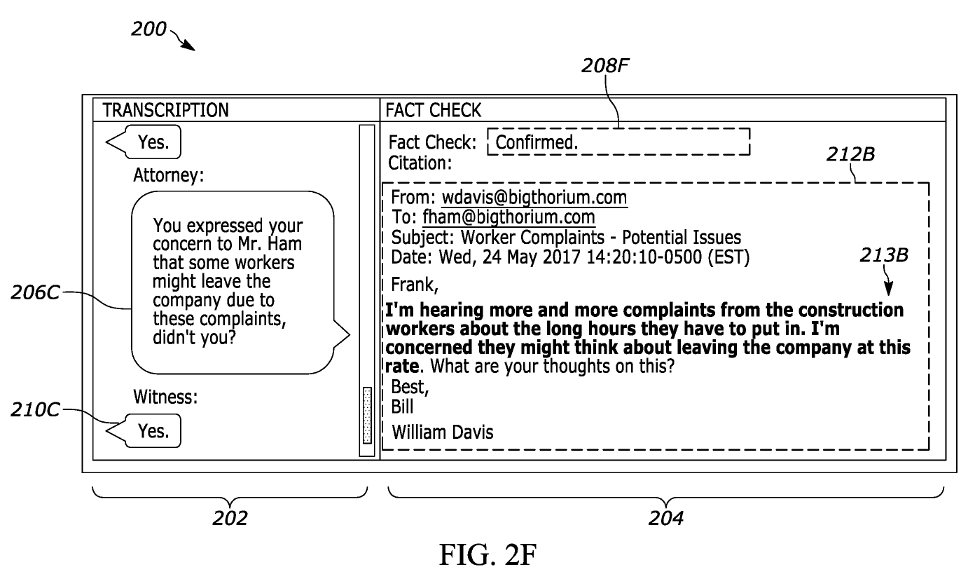

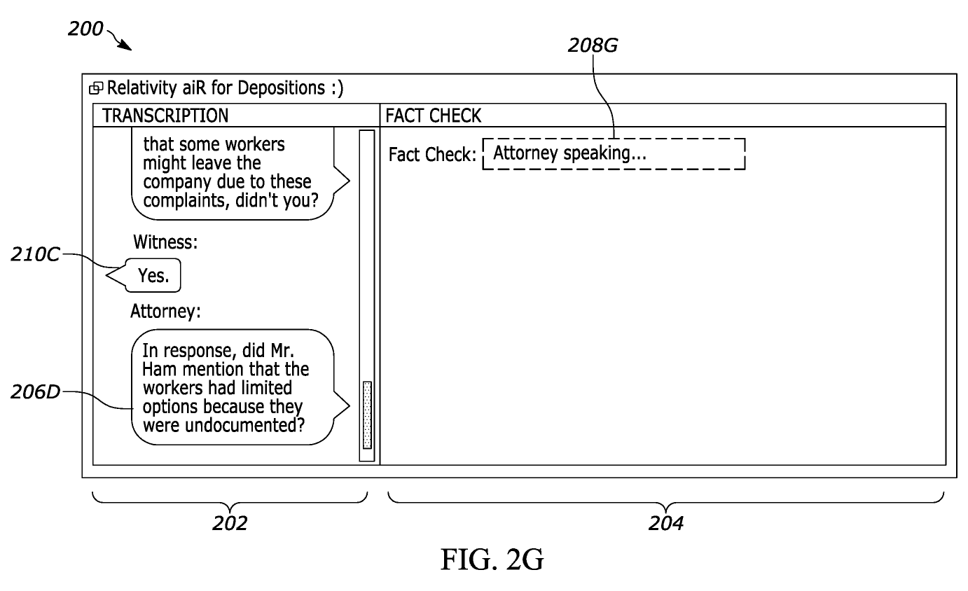

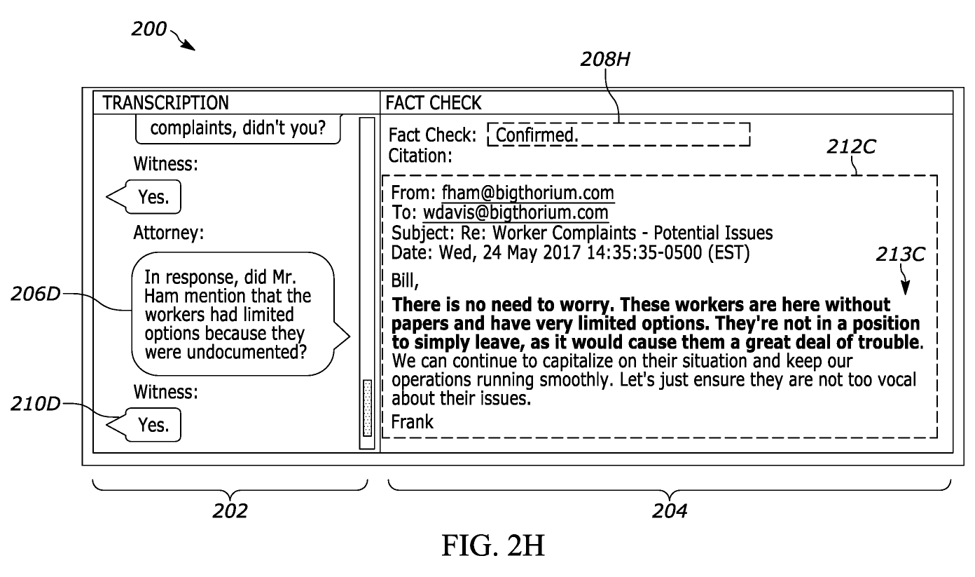

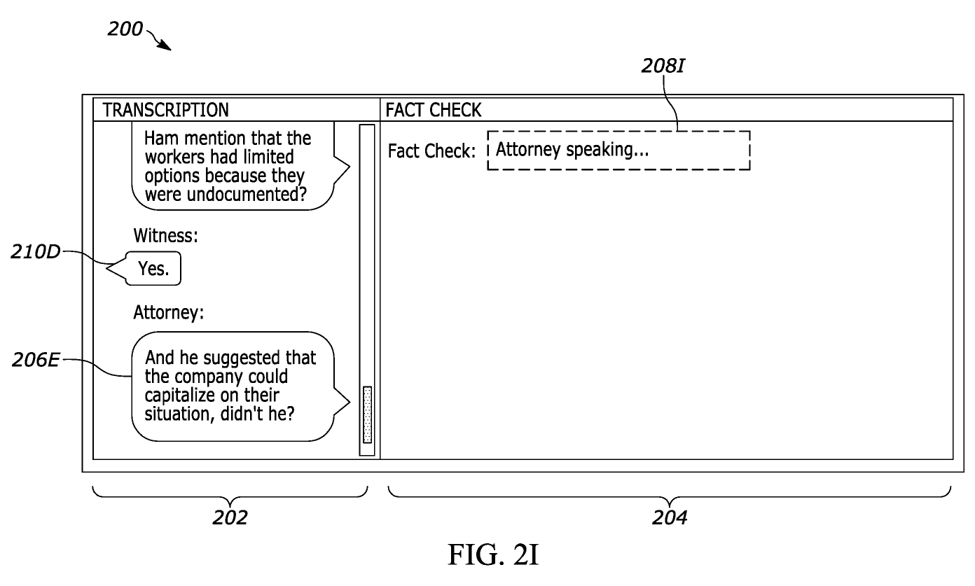

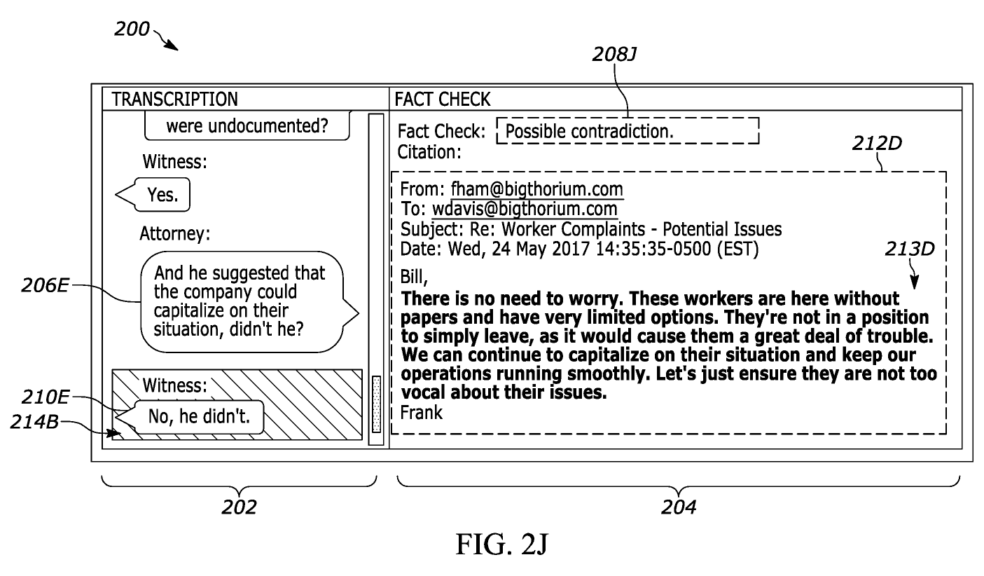

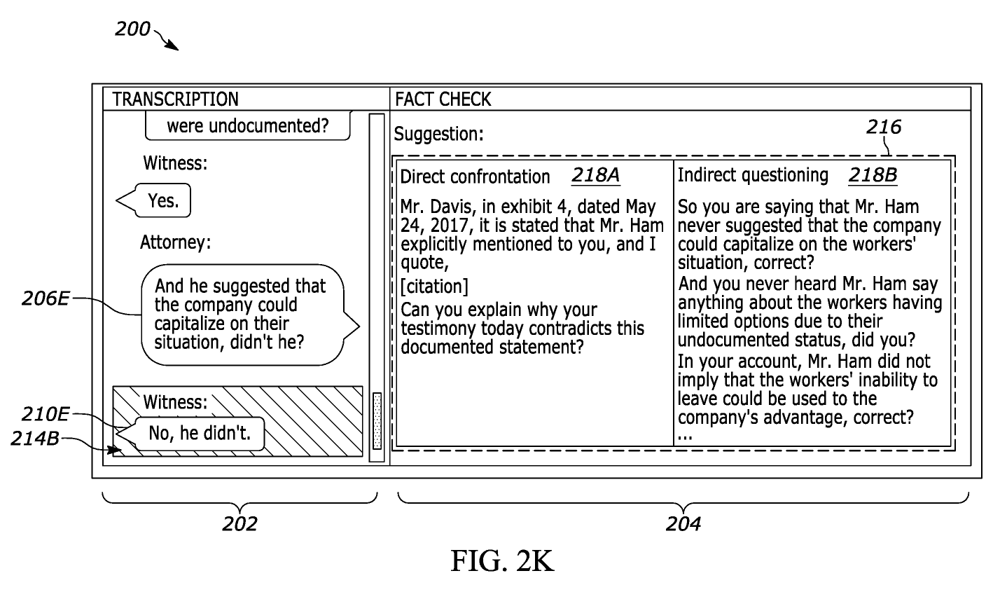

In some embodiments, the deposition analysis prompt 116 may include indicator rules that direct the deposition analysis machine learning model 108 to generate a indicator for the deposition data 110 based on the supportive or contradictory objects identified. The indicator rules may also direct the deposition analysis ML model 108 to generate an indicator of the accuracy of the deposition data 110 and include the indicator in the response 114. For example, the deposition analysis ML model 108 may generate indicators noting that a question answer includes material not included in the relevant objects 112 (see e.g., first indicator 214A in FIG. 2D) or is contradicted (see e.g., second indicator 214B in FIG. 2J) by at least one of the relevant objects 112.

In some embodiments, the deposition analysis prompt 116 may include objection definitions and instructions that direct the deposition analysis machine learning model 108 to compare the deposition data 110 to the objection definitions and include an objection recommendation in the response 114. Example, objections may include identifying compound questions, argumentative questions, questions that have already been asked and answered, questions that assumes facts not in evidence, questions that call for the witness or deponent to speculate, leading questions, questions that calls for legal conclusion or lay opinions, etc. Furthermore, in some embodiments, different objection rules may apply based on the identified role of the current speaker. In particular, the objection rules may be different for statements made by deponents and statements made by counsel.

With reference now to FIG. 1B an alternative computing environment 100B is shown. The computing environment 100B includes the elements of the computing environment 100A described above except that the processing unit 104 is configured to generate search queries 118A from the deposition data 110 to use in identifying the relevant objects 112.

As shown in FIG. 1B, the processing unit 104 may generate the search queries 118A from the deposition data 110 and query the data store 120 for the relevant objects 112 using the search queries 118A. In particular, the processing unit 104 may convert the deposition data 110 such as the transcript data portions into the search queries 118A. The processing unit 104 may query the set of workspace objects 103 in the data store 120 with the search queries 118A and select results of the query as the relevant objects 112. The processing unit 104 may convert the transcript data into the search queries 118A by identifying words or segments of text in the transcript data as the search queries 118A. The words or segments of text may include one or more of general person names, general entity names, general location names, general item names, dates, and general legal terminology. In some embodiments, the processing unit 104 may employ a ML model to identify the words or segments. For example, the processing unit 104 may instruct a large language model or other ML type model to identify text in the deposition data 110 that is indicative generally of a person names, entity names, location names, item names, dates, and other terminology. In some embodiments, the processing unit 104 may use the deposition analysis ML model 108 to generate the search queries 118A. The processing unit 104 may then use the relevant objects 112, the deposition data 110, and the deposition analysis prompt 116 to generate the response 114 using the deposition analysis ML model 108 in the same manner as described above with respect to the computing environment 100A.

With reference now to FIG. 1C an alternative computing environment 100C is shown. The computing environment 100C includes the elements of the computing environments 100A and 100B described above except that the processing unit 104 is configured to generate search queries 118B rather than the search queries 118A. In particular, the processing unit 104 generates the search queries 118B shown in FIG. 1C from the workspace objects 103. The search queries 118B may include words or segments of text related to the workspace objects 103. For example, the search queries 118B may include words or segments of text from the workspace objects 103 such as one or more of person names, entity names, location names, item names, dates, and terminology relating to legal issues presented by the matter. Each query in the search queries 118B is associated with a respective subset of the set of workspace objects 103. For example, different ones of the search queries 118B may be associated with particular documents, fact objects, etc.

In some embodiments, the processing unit 104 may employ a ML model to identify the words or segments from the workspace objects 103. For example, the processing unit 104 may instruct a large language model or other ML type model to identify text in the workspace objects 103 that is indicative generally of person names, entity names, location names, item names, dates, and other terminology. In some embodiments, the processing unit 104 may use the deposition analysis ML model 108 to generate the search queries 118A. Furthermore, in some embodiments, the processing unit 104 may generate the words or segments when generating the data object portions of the workspace objects 103. For example, the processing unit 104 may generate fact objects or other similar data objects of the workspace objects 103 so that each object includes a search term or segment field from which the processing unit 104 may compile the search queries 118B.

To identify the relevant objects 112, the processing unit 104 of the alternative computing environment 100C, queries the deposition data 110 to identify matched queries 126 to the search queries 118B. Then, the processing unit 104 selects, as the relevant objects 112, the respective subset of the set of workspace objects 103 that are associated with the matched queries 126. The processing unit 104 may then use the relevant objects 112, the deposition data 110, and the deposition analysis prompt 116 to generate the response 114 using the deposition analysis ML model 108 in the same manner as described above with respect to the computing environment 100A.

With reference now to FIG. 1D an alternative computing environment 100D is shown. The computing environment 100D includes the elements of the computing environments 100A, 100B, or 100C described above and may identify the relevant objects 112 in any manner described herein. As illustrated, the alternative computing environment 100D includes a behavior classification ML model 128. The processing unit 104 may input the deposition data 110 and a behavior classification prompt 130 into the behavior classification ML model 128 to generate a behavior assessment 132. The behavior classification prompt 130 controls how the behavior classification ML model 128 analyzes the deposition data 110 to identify a behavior of the witness, deponent, attorney, etc, and generate the behavior assessment 132 to indicate the identified behavior. The identified behavior may describe the manner in which a witness, deponent, etc. answers a question portion of the deposition data 110 such as a tone, sentiment, emotional state etc. For example, the behavior assessment 132 may indicate that the witness or deponent was evasive, angry, calm, enthusiastic, etc.

Furthermore, as shown in FIG. 1D, the processing unit 104 may input the behavior assessment 132 to the deposition analysis ML model 108 and/or the response 114. In these embodiments, the deposition analysis prompt 116 may include behavior assessment rules that direct the deposition analysis machine learning model 108 on how to analyze the behavior assessment 132 to generate portions of the response 114. For example, the deposition analysis ML model 108 may include different response suggestions within the response 114 based on the behavior assessment 132 such as recommending a direct follow-up question to an angry or evasive witness or deponent. It should be appreciated that in some embodiments, the behavior classification ML model 128 may be combined with the deposition analysis ML model 108 into a single ML model that generates the behavior assessment 132 and the response 114. In these embodiments the behavior classification prompt 130 and the deposition analysis prompt 116 may be combined as a single prompt input to the combined ML model.

In some embodiments, the behavior classification ML model 128 and/or the behavior classification prompt 130 may be dynamically revised during the course of the deposition event to reflect behavioral traits learned about the specific parties participating in the deposition event. For example, the behavior classification ML model 128 and/or the behavior classification prompt 130 may be updated to identify particular behavior of a witness with untruthfulness based on a determined correlation with that behavior and the deposition analysis ML model 108 identifying contradictory objects for witness statements given while exhibiting the particular behavior.

In general, the response 114 that is generated by the deposition analysis ML model 108 in any of the computing environments 100A, 100B, 100C, and 100D described herein may include content to guide future portions of the deposition event. As described herein, this content can include the behavior assessment 132, follow up question or other suggested response options, indications of supportive or contradictory documents or data objects of the workspace objects 103, summary reports or reminders of key features of the matter mentioned in the deposition data 110, etc. In some embodiments, the response 114 may be presented in a graphical user interface of the client device 122. In particular, the client device 122 may display the response 114 as part of a user interface window 200.

It should be appreciated that the deposition analysis ML model 108 and other components of the workspace 102 as shown in the computing environments 100A, 100B, 100C, and 100D may instead be included as part of the client device 122. For example, in some embodiments, the client device 122 may include processors and memory that locally execute the deposition analysis ML model 108 or behavior classification ML model 128 to generate the response 114 and behavior assessment 132 without needing to connect to the workspace 102 over a network.

It should also be appreciated that, in some embodiments, the deposition data 110 may include non-real time data related to one or more depositions events. For example, the deposition data 110 may include text transcripts, audio recordings, video recordings, etc. of one or more historical deposition events. In these embodiments, the processing unit 104 may identify the relevant objects 112 and use as inputs to the deposition analysis ML model 108 to generate the response 114 as part of preparation for depositions and/or trial cross-examination. For example, any contradictory document or fact objects identified in the response 114 may be flagged for inquiry at a subsequent deposition or trial cross-examination. Furthermore, in some embodiments, the processing unit 104 may batch process depositions data relating to different deposition events to increase processing efficiency and resources. For example, in advance of the trial, the 104 may process some or all of the deposition transcripts in the manner described herein to generate the response 114 that collectively indicates all deposition testimony that is contradicted by the relevant objects 112 and/or the full set of workspace objects 103. The response 114 may then be analyzed for purposes of preparing plans, guides, or other materials relating to cross-examination, opening statements, closing statements, and/or other trial related documents and motions.

A particular example of the user interface window 200 used to present the response 114 is shown in FIGS. 2A-2K. As illustrated, the user interface window 200 may include a transcript section 202 and a response section 204. The transcript section 202 may be configured to display a real-time transcript section of the deposition event. In some embodiments, the processing unit 104 of workspace 102 and/or the client device 122 may generate the real-time transcript. The response section 204 may be configured to display portions of the response 114 or other elements generated by the processing unit 104 from the deposition data 110.

An example operation to generate and display the response 114 will be described in connection with FIGS. 1A-2K collectively. First, as shown in FIG. 2A, the transcript section 202 displays a first question portion 206A that the processing unit 104 or the client device 122 identified from the deposition data 110. The response section 204 displays a first status identifier 208A that the deposition analysis ML model 108 generates as part of the response 114. The first status identifier 208A provides information about the first question portion 206A as understood by the deposition analysis ML model 108 such as the fact that an “attorney is speaking.” This live feedback provided within the user interface window 200 enables the user to verify that the deposition analysis ML model 108 is operating correctly to identify and comprehend the first question portion 206A.

As shown in FIG. 2B, in response to the witness or deponent answering the first question portion 206A, the transcript section 202 displays a first answer portion 210A that the processing unit 104 or the client device 122 identified from the deposition data 110. The response section 204 is then updated to display a second status identifier 208B and a first citation 212A that the deposition analysis ML model 108 generates as part of the response 114. As shown in FIG. 2B, the second status identifier 208B provides an indication, generated by the deposition analysis ML model 108, of how the first answer portion 210A relates to the first question portion 206A, which in this example is “confirmed.” In particular, the “confirmed” indication of the second status identifier 208B indicates that the deposition analysis ML model 108 identified at least one element in the relevant objects 112 as supporting or confirming the first answer portion 210A.

Furthermore, the first citation 212A may include a complete document or document excerpt that verifies the first status identifier 208A. For example, as shown in FIG. 2B, the first citation 212A includes an email communication that confirms that the first answer portion 210A is correct. The first citation 212A may relate to the at least one element in the relevant objects 112 that the deposition analysis ML model 108 identified as supporting or confirming the first answer portion 210A. For example, the email communication excerpt displayed as the first citation 212A may itself be the element identified by the deposition analysis ML model 108 or the identified element may include a data object (e.g., a fact object) that references the email communication. In cases where the identified element references a source document such as the email communication, the identified element may contain a summary or text excerpt that the deposition analysis ML model 108 identifies as confirming or supporting the first answer portion 210A. Additionally, as shown in FIG. 2B, the first citation 212A may include a first emphasis overlay 213A (e.g., text bolding, underlining, highlighting etc.) that calls attention to the most relevant portion of the first citation 212A. In some embodiments, the first citation 212A may include only an excerpt of the relevant portion.

As shown in FIG. 2C, the transcript section 202 may display a second question portion 206B after the first answer portion 210A. The response section 204 includes display of a third status identifier 208C that the deposition analysis ML model 108 generates as part of the response 114. The third status identifier 208C provides information about the second question portion 206B as understood by the deposition analysis ML model 108 such as the fact that the “attorney is speaking” again.

As shown in FIG. 2D, in response to the witness or deponent answering the second question portion 206B the transcript section 202 displays a second answer portion 210B that the processing unit 104 or the client device 122 identified from the deposition data 110. The response section 204 is then updated to display a fourth status identifier 208D that the deposition analysis ML model 108 generates as part of the response 114. As shown in FIG. 2D, the fourth status identifier 208D provides an indication, generated by the deposition analysis ML model 108, of how the second answer portion 210B relates to the second question portion 206B and the workspace objects 103, which in this example is “new information.” In particular, the “new information” indication of the fourth status identifier 208D indicates that the deposition analysis ML model 108 failed to identify an element in the relevant objects 112 that either supported or confirmed the second answer portion 210B. Furthermore, as shown in FIG. 2D, the transcript section 202 may display a first indicator 214A that is related to the content of the fourth status identifier 208D. For example, the first indicator 214A may include overlaying the second answer portion 210B with a color indicator that corresponds to the “new information” determination. Additional types of indicators are also possible such as various display icons, flags, etc.

As shown in FIG. 2E, the transcript section 202 may display a third question portion 206C after the second answer portion 210B. The response section 204 includes display of a fifth status identifier 208E that the deposition analysis ML model 108 generates as part of the response 114. The fifth status identifier 208E provides information about the third question portion 206C as understood by the deposition analysis ML model 108 such as the fact that the “attorney is speaking” again.

As shown in FIG. 2F, in response to the witness or deponent answering the third question portion 206C the transcript section 202 displays a third answer portion 210C that the processing unit 104 or the client device 122 identified from the deposition data 110. The response section 204 is then updated to display a sixth status identifier 208F and a second citation 212B that the deposition analysis ML model 108 generates as part of the response 114. As shown in FIG. 2F, the sixth status identifier 208F provides an indication, generated by the deposition analysis ML model 108, of how the third answer portion 210C relates to the third question portion 206C, which in this example is “confirmed.” In particular, the “confirmed” indication of the sixth status identifier 208F indicates that the deposition analysis ML model 108 identified at least one element in the relevant objects 112 as supporting or confirming the third answer portion 210C.

Furthermore, the second citation 212B may include a complete document or document excerpt that verifies the sixth status identifier 208F. For example, as shown in FIG. 2F, the second citation 212B includes an email communication that confirms that the second answer portion 210B is correct. The second citation 212B may relate to the at least one element in the relevant objects 112 that the deposition analysis ML model 108 identified as supporting or confirming the third answer portion 210C. For example, the email communication excerpt displayed as the second citation 212B may itself be the element identified by the deposition analysis ML model 108 or the identified element may include a data object (e.g., a fact object) that references the email communication. In cases where the identified element references a source document such as the email communication, the identified element may contain a summary or text excerpt that the deposition analysis ML model 108 identifies as confirming or supporting the third answer portion 210C. Additionally, as shown in FIG. 2F, the second citation 212B may include a second emphasis overlay 213B (e.g., text bolding, underlining, highlighting etc.) that calls attention to the most relevant portion of the second citation 212B. In some embodiments, the second citation 212B may include only an excerpt of the relevant portion.

As shown in FIG. 2G, the transcript section 202 may display a fourth question portion 206D after the third answer portion 210C. The response section 204 includes display of a seventh status identifier 208G that the deposition analysis ML model 108 generates as part of the response 114. The seventh status identifier 208G provides information about the fourth question portion 206D as understood by the deposition analysis ML model 108 such as the fact that the “attorney is speaking” again.

As shown in FIG. 2H, in response to the witness or deponent answering the fourth question portion 206D the transcript section 202 displays a fourth answer portion 210D that the processing unit 104 or the client device 122 identified from the deposition data 110. The response section 204 is then updated to display an eighth status identifier 208H and a third citation 212C that the deposition analysis ML model 108 generates as part of the response 114. As shown in FIG. 2H, the eighth status identifier 208H provides an indication, generated by the deposition analysis ML model 108, of how the fourth answer portion 210D relates to the fourth question portion 206D, which in this example is “confirmed.” In particular, the “confirmed” indication of the sixth status identifier 208F indicates that the deposition analysis ML model 108 identified at least one element in the relevant objects 112 as supporting or confirming the fourth answer portion 210D. The third citation 212C may include an email document identified and selected by the processing unit 104 using the deposition analysis ML model 108 in a manner similar to that of the first and second citations 212A and 212B described above. Furthermore, the third citation 212C may include a third emphasis overlay 213C similar to the first and second emphasis overlays 213A and 213B.

As shown in FIG. 2I, the transcript section 202 may display a fifth question portion 206E after the fourth answer portion 210D. The response section 204 includes display of a ninth status identifier 208I that the deposition analysis ML model 108 generates as part of the response 114. The ninth status identifier 208I provides information about the fifth question portion 206E as understood by the deposition analysis ML model 108 such as the fact that the “attorney is speaking” again.

As shown in FIG. 2J, in response to the witness or deponent answering the fifth question portion 206E the transcript section 202 displays a fifth answer portion 210E that the processing unit 104 or the client device 122 identified from the deposition data 110. The response section 204 is then updated to display a tenth status identifier 208J and a fourth citation 212D that the deposition analysis ML model 108 generates as part of the response 114. As shown in FIG. 2J, the tenth status identifier 208J provides an indication, generated by the deposition analysis ML model 108, of how the fifth answer portion 210E relates to the fifth question portion 206E, which in this example is “possible contradiction.” In particular, the “possible contradiction” indication of the tenth status identifier 208J indicates that the deposition analysis ML model 108 identified at least one element in the relevant objects 112 as contradicting the fifth answer portion 210E.

Furthermore, the fourth citation 212D may include a complete document or document excerpt that verifies the tenth status identifier 208J. For example, as shown in FIG. 2J, the fourth citation 212D includes an email communication that confirms that the fifth answer portion 210E is inaccurate (e.g., the witness or deponent is lying, misinformed, misremembering, etc.). The fourth citation 212D may relate to the at least one element in the relevant objects 112 that the deposition analysis ML model 108 identified as contradicting the fifth answer portion 210E. For example, the email communication excerpt displayed as the fourth citation 212D may itself be the element identified by the deposition analysis ML model 108 or the identified element may include a data object (e.g., a fact object) that references the email communication. In cases where the identified element references a source document such as the email communication, the identified element may contain a summary or text excerpt that the deposition analysis ML model 108 identifies as confirming or supporting the fifth answer portion 210E. Additionally, as shown in FIG. 2J, the fourth citation 212D may include a fourth emphasis overlay 213D (e.g., text bolding, underlining, highlighting etc.) that calls attention to the most relevant portion of the fourth citation 212D. In some embodiments, the fourth citation 212D may include only an excerpt of the relevant portion.

Furthermore, as shown in FIG. 2J, the transcript section 202 may display a second indicator 214B that is related to the content of the tenth status identifier 208J. For example, the second indicator 214B may include overlaying the fifth answer portion 210E with a color indicator that corresponds to the “possible contradiction” determination. Additionally the color indicator can be different from the color indicator used for the first indicator 214A shown in FIG. 2D so that the user of the user interface window 200 may quickly understand the contents of the relevant status identifier. Additional types of indicators are also possible such as various display icons, flags, etc.

As shown in FIG. 2K, the response section 204 may display response suggestions 216 after displaying the fourth citation 212D shown in FIG. 2J. The response suggestions 216 may include possible response suggestions to the contradicted fifth answer portion 210E that were generated by the deposition analysis ML model 108 and included in the response 114. In particular, the response suggestions 216 may include a different follow up question options such as a direct conformation question 218A or an indirect question 218B. The direct conformation question 218A may provide example question text that directly confronts the witness or deponent with the fourth citation 212D while the indirect question 218B may provide example question text that incorporates the details of the fourth citation 212D without an explicit reference to the contradictory document associated with the fourth citation 212D.

It should also be appreciated that the response section 204 may display follow up questions and other recommendations in response to answer portions that the deposition analysis ML model 108 identifies as confirmed or new. For example, the deposition analysis ML model 108 may generate follow up questions to include in the response 114 that remined the questioner to ask questions relating to material in a deposition outline. The material may include specific questions the deposing attorney or questioner wants to ask or general types of questions and information the attorney or questioner wants to gather from the witness or deponent. Furthermore, in some embodiments, the response 114 may include a summary report or reminders of key features of the matter. In particular, such reports or reminders may relate to people, entities, events, etc. that the witness or questioner mentions in the deposition data 110. For example, where a witness mentions a particular person the response 114 may include a summary of all known facts about that person that as indicated by the workspace objects 103.

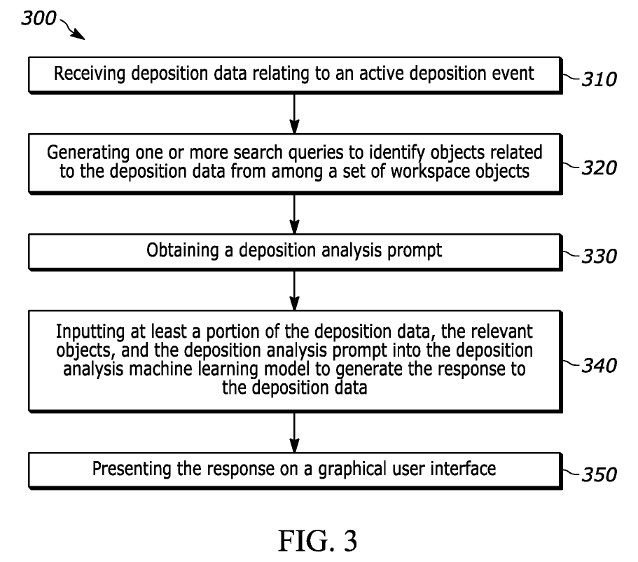

FIG. 3 shows a computer-implemented method 300 for using the deposition analysis ML model 108 to generate the response 114. The method 300 may be performed by the processing unit 104 executing instructions stored on the memory unit 106 to support the various modules described herein that are executed within the workspace 102.

At block 310, the method 300 includes receiving deposition data (e.g., the deposition data 110) relating to an active deposition event, wherein the deposition data includes one or more of transcript data and image data. The transcript data may include one or more of transcribed text from the deposition event, and audio of the deposition event. The image data may include real-time video of the deposition event.

At block 320, the method 300 includes generating one or more search queries (e.g., the search queries 118A or 118B) to identify objects (e.g., relevant objects 112) related to the deposition data from among a set of workspace objects (e.g., the workspace objects 103). The set of workspace objects may include a plurality of fact objects generated from a corpus of documents. The set of workspace objects may also include a corpus of documents.

In some embodiments, the generating the one or more search queries and identifying the relevant objects may include converting the transcript data into the one or more search queries, querying the set of workspace objects with the one or more search queries, and selecting results of the query as the relevant objects. Converting the transcript data into the one or more search queries may include identifying words or segments of text in the transcript data as the one or more search queries. The words or segments of text include one or more of general person names, general entity names, general location names, general item names, dates, and general legal terminology.

In some embodiments, generating the one or more search queries and identifying the relevant objects may include identifying the one or more search queries as words or segments of text related to the set of workspace objects. Each query in the one or more search queries may be associated with a respective subset of the set of workspace objects. Generating the one or more search queries and identifying the relevant objects may also include querying the deposition data for matches to the one or more search queries and selecting, as the relevant objects, the respective subset of the set of workspace objects associated with each query of the one or more search queries that produces a match with the deposition data. The words or segments of text from the set of workspace objects may include one or more of person names, entity names, location names, item names, dates, and terminology relating to matter related legal issues.

At block 330, the method 300 includes obtaining a deposition analysis prompt (e.g., deposition analysis prompt 116). The deposition analysis prompt is configured to control how a deposition analysis machine learning model (e.g., deposition analysis ML model 108) analyzes the deposition data and the relevant objects to generate a response (e.g., response 114) to the deposition data.

In some embodiments, the deposition analysis prompt includes question generating rules that direct the deposition analysis machine learning model to identify supportive or contradictory objects of the relevant objects that support or contradict the deposition data by comparing the deposition data to the relevant objects. The generating rules may also direct the deposition analysis machine learning model to generate follow up questions based on the supportive or contradictory objects and include the follow up questions in the response. The deposition analysis prompt may also include indicator rules that direct the deposition analysis machine learning model to generate an indicator for the deposition data based on the supportive or contradictory objects identified and include the indicator for the deposition data in the response. The supportive or contradictory objects may include electronic documents that support or contradict the deposition data and identifiers of the supportive or contradictory documents may be included in the response. The method 300 may include presenting at least a portion of the supportive or contradictory documents on the graphical user interface with the response. In some embodiments, the deposition analysis prompt includes objection definitions and instructions that direct the deposition analysis machine learning model to compare the deposition data to the objection definitions and include an objection recommendation in the response when at least a portion of the deposition data satisfies one or more of the objection definitions.

At block 340, the method 300 includes inputting at least a portion of the deposition data, the relevant objects, and the deposition analysis prompt into the deposition analysis machine learning model to generate the response to the deposition data. The at least a portion of the deposition data input into the deposition analysis machine learning model may include segmented text blocks of the deposition data. In these embodiments, the method 300 may include identifying segmentation markers present in the deposition data as the deposition data is received and selecting portions of the deposition data between identified segmentation markers as the segmented text blocks. The segmentation markers may include one or more of a change in speaker or a time pause in receipt of new portions of the deposition data that exceeds a preconfigured threshold.

At block 350, the method 300 includes presenting the response on a graphical user interface (e.g., user interface window 200).

In some embodiments, the deposition data includes video or audio data. In these embodiments, the method 300 may include inputting the video or audio data into a behavior classification machine learning model to generate a behavior assessment of the deposition data and including the behavior assessment in the response. The method 300 may also include inputting the behavior assessment into the deposition analysis machine learning model. The deposition analysis prompt may include behavior assessment rules that direct the deposition analysis machine learning model on how use the behavior assessment to generate the response to the deposition data.

### SIMULATING A DEPOSITION TO IDENTIFY OBJECTS TO PRE-LOAD INTO A CACHE OF A CLIENT DEVICE

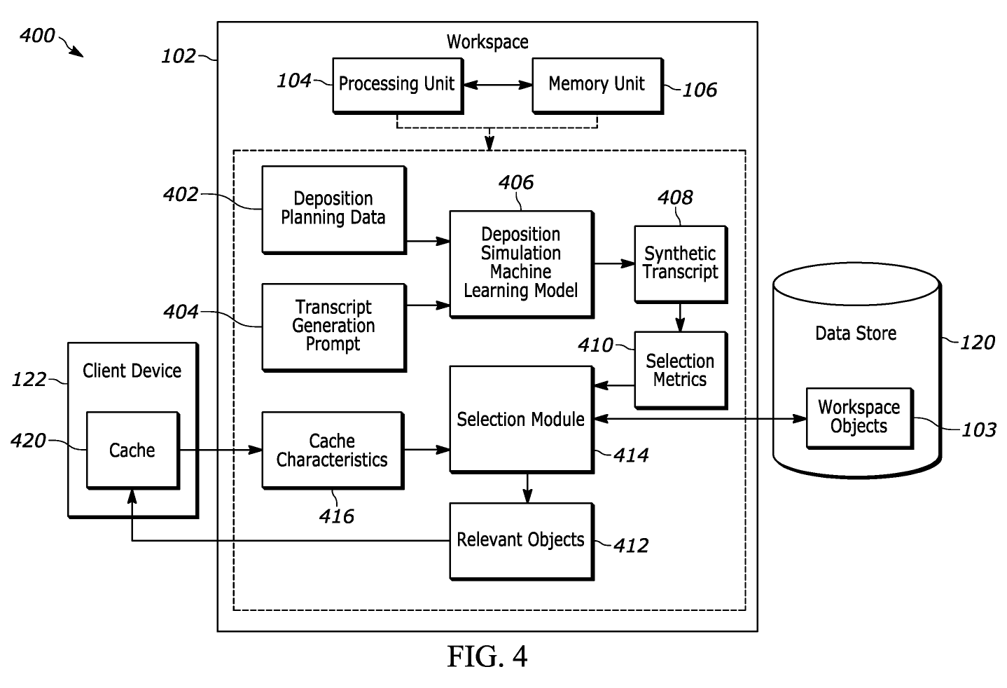

With reference now to FIG. 4, another computing environment 400 is shown. The computing environment 400 may include portions of the computing environments 100A-D as described herein. For example, as shown in FIG. 4, the computing environment 400 may include the workspace 102, the processing unit 104, the memory unit 106, the data store 120 and workspace objects 103 stored therein, and the client device 122.

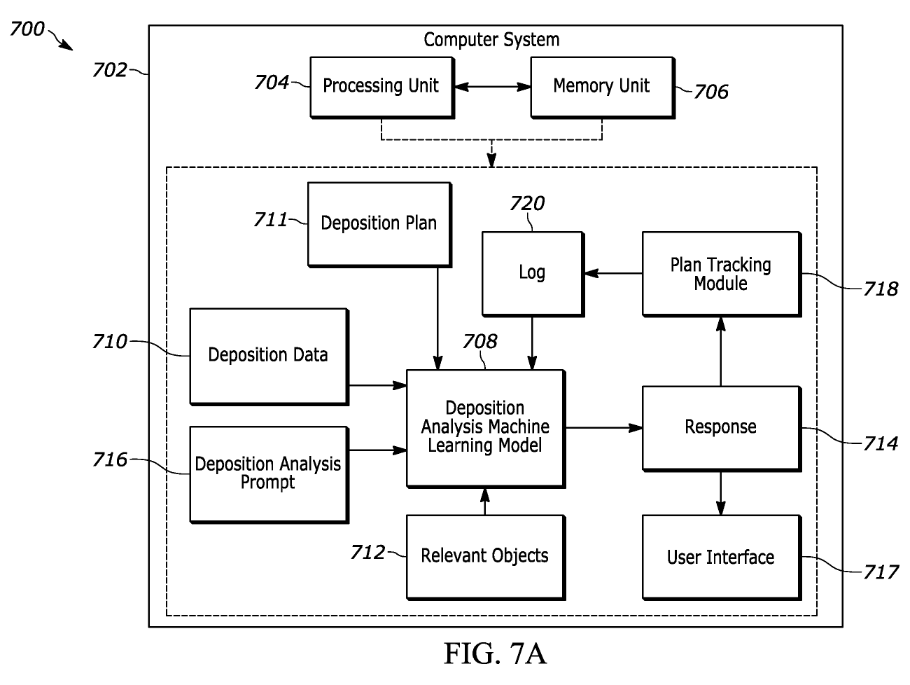

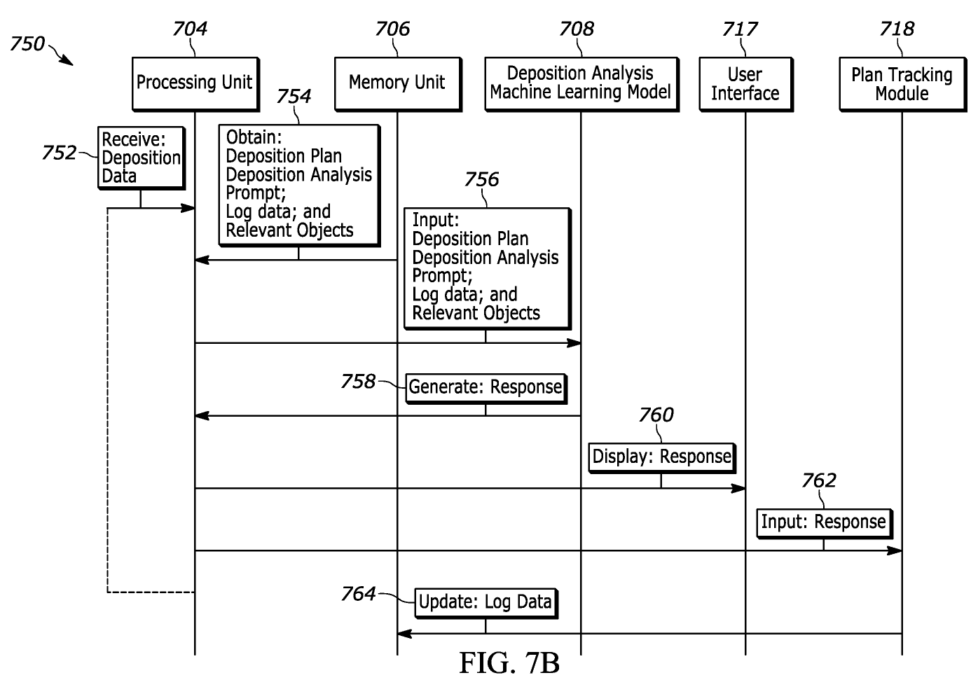

As described herein, the client device 122 may be configured to locally execute a machine learning model (e.g., the deposition analysis ML model 108 of FIGS. 1A-1D, the deposition analysis ML model 708 of FIG. 7AA, etc.) to analyze deposition data (e.g., deposition data 110, deposition data 710, etc.) relative to one or more of the workspace objects 103 and generate recommended responses (e.g., response 114, response 714, etc.) thereto. To facilitate local execution of the ML model, the processing unit 104 may preload a locally accessible cache 420 of the client device 122 with relevant objects 412 selected from among the workspace objects 103.

Local execution of the ML model by the client device 122 using locally accessible copies of the relevant objects 412 enables lower latency generation of the recommended responses as compared with an at least partially remote execution (e.g., where the ML model or the relevant objects 412 are accessible over a wide area network such as the internet) because the client device 122 does not need to connect to the workspace 102 and/or the data store 120 to generate the response and/or to retrieve the relevant objects 412. However, because the cache 420 generally has an amount of allocatable space that is less than that of the data store 120, the cache 420 is unable to store copies of all the workspace objects 103. As such, the processing unit 104 is configured to select the relevant objects 412 as a subset of the workspace objects 103 based on relevance to the deposition event and the actual amount of allocatable space within the cache 420.

The cache 420 may be an internal component of the client device 122 or a component that that is configured to connect to client device 122. In any case the connection between the cache 420 and the client device 122 may include a local data transfer connection (e.g., an external wired connection, an external local area wireless connection, an internal connection of the client device 122, etc.). For example, the cache 420 may include an external removable storage drive (e.g., SSD, hard drive, USB drive, etc.) or an internal drive of the client device 122 (e.g., an SSD, hard drive, memory, etc.). The cache 420 may be connected either directly or remotely to the workspace 102 to receive the relevant objects 412 for storage therein. In embodiments where the cache 420 is an internal component of the client device 122, the client device 122 may receive the relevant objects 412 from the processing unit 104 and store the relevant objects 412 in the cache 420 so they are accessible to the client device 122 when locally executing the ML model. However, in embodiments where the cache 420 externally connects to the client device 122, a device different from the client device 122 may store the relevant objects 412 in the cache 420.

In general, the computing environment 400 may use the workspace 102 to generate a synthetic deposition transcript for use in identifying relevant objects 412 to preload into the cache 420 of the client device 122. The preloaded relevant objects may then be used by the client device 122 to analyze a live deposition event using locally executed version of the deposition analysis ML model 108 as described above. In particular, by preloading the relevant objects into the cache 420 of the client device 122, the deposition analysis ML model 108 may be executed and performed without a network connection to the workspace 102, thereby facilitating fast analysis of data generated during the deposition event to provide real-time guidance on how to conduct the deposition.

As shown in FIG. 4, the processing unit 104 may receive deposition planning data 402 that relates to a future deposition event. The deposition planning data 402 may indicate features of the future deposition event such as identifiers of the deponent identifier, attorneys or other persons involved, a plurality of deposition objectives, and/or other background material or important details about the future deposition event. The processing unit 104 may receive the deposition planning data 402 as from the client device 122 or from a similar user interface device in electronic communication with the workspace 102. Furthermore, the processing unit 104 may receive the deposition planning data 402 as an upload, user input to a graphical user interface provided by the workspace 102, and/or other means of data sharing and input known in the art.

The processing unit 104 may also obtain a transcript generation prompt 404 that includes instructions that direct a deposition simulation machine learning model 406 on how to analyze and process portions of the deposition planning data 402 to generate a synthetic transcript 408. In some embodiments the transcript generation prompt 404 may be generated or customized based on the deposition planning data deposition planning data 402. For example, the processing unit 104 may obtain or generate different instructions to include within the transcript generation prompt 404 based on the people involved in the planned deposition event and/or their respective roles with respect to the deposition event. For instance, the role may indicate whether the user of the workspace 102 will be defending or conducting the planned deposition event.

As another example, in embodiments where the deposition planning data 402 includes the plurality of deposition objectives, the transcript generation prompt 404 may include instructions that direct the deposition simulation machine learning model 406 to synthetically simulate the future deposition event in a manner that addresses the plurality of deposition objectives. Accordingly, the transcript generation prompt 404 may include instructions on how to determine whether a deposition objective has been achieved and/or how to convert a deposition objective into one or more questions to be asked to the deponent.

In some embodiments, one of the deposition objectives or other material in the deposition planning data 402 may relate to or specifically identify one or more of the workspace objects 103 stored in the data store 120. Additionally or alternatively, the processing unit 104 may be configured to parse the deposition planning data 402 for keywords and phrases or semantically matching text associated with specific ones of the workspace objects 103 to identify the related objects. This process may be similar to the process described above where the processing unit 104 identifies relevant objects 112 from deposition data deposition data 110 using the search queries 118A and 118B. Regardless, the processing unit 104 may retrieve the related objects from the data store 120 for inclusion as an input into the deposition simulation machine learning model 406. In this way, the deposition simulation machine learning model 406 may generate the synthetic transcript 408 using known information and insights of the matter with which the deposition event is related.

Furthermore, as described in more detail below the transcript generation prompt 404 may include a series of different prompts that are iteratively input into the deposition simulation machine learning model 406 to generate text snippets or portions that the processing unit 104 combines together to form the synthetic transcript 408.

The deposition simulation machine learning model 406 may analyze the deposition planning data 402 as directed by the transcript generation prompt 404 to generate the synthetic transcript 408. The deposition simulation machine learning model 406 comprises a set of interconnected nodes, layers, trained parameter values (e.g., multiplicative weights, additive bias, etc.), etc. The trained parameters are set via backpropagation or other similar techniques in a training process that uses historical data inputs to identify or recognize patterns and trends therein. For example, in some embodiments, the deposition simulation machine learning model 406 may be trained or tuned on historical deposition transcripts and similar data.

Various architectures for the deposition simulation machine learning model 406 are possible, including, but not limited to, convolutional neural network (CNN) architectures, transformer architectures, recurrent/recursive neural network (RNN) architectures, sorting/clustering architectures, etc. In some embodiments, the deposition simulation machine learning model 406 includes a large language model (LLM), a reasoning model, a lightweight language model, and/or other types of suitable language models. The model 406 can be a base model trained by a third party and accessed by the workspace 102 via an application programming interface (API). The model 406 can also be a fine-tuned public model (e.g., a model that is initially trained on publicly available or third-party data and tuned using private/proprietary data accessible by the workspace 102) or a full privately trained model managed by the workspace 102 (e.g., a model that is fully trained by the workspace 102 on private/proprietary data and/public data accessible thereto).

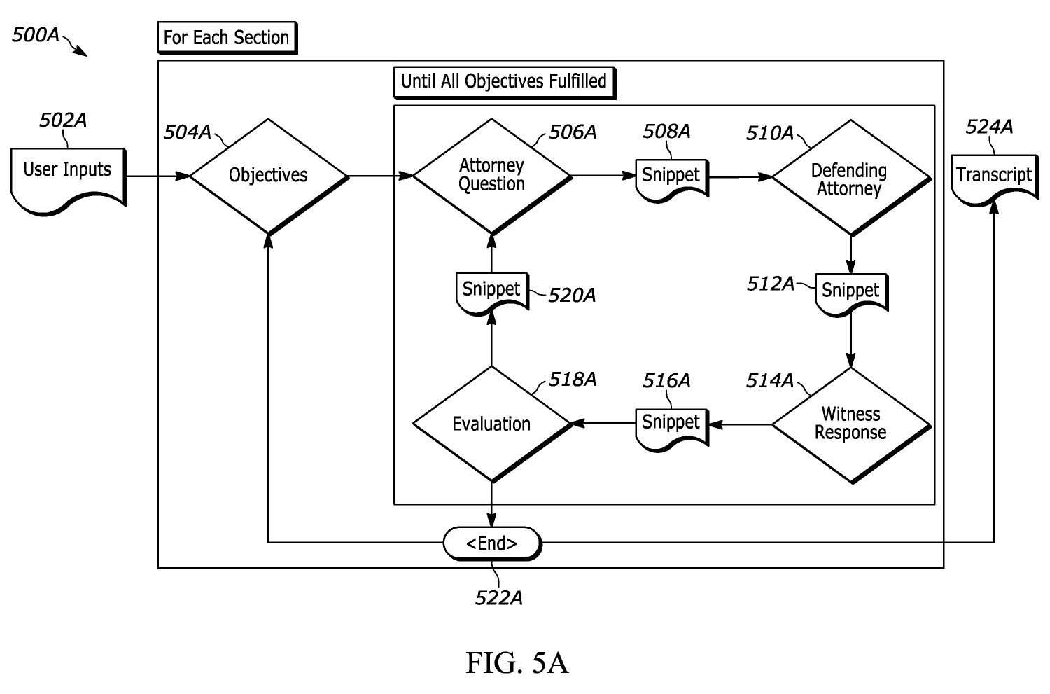

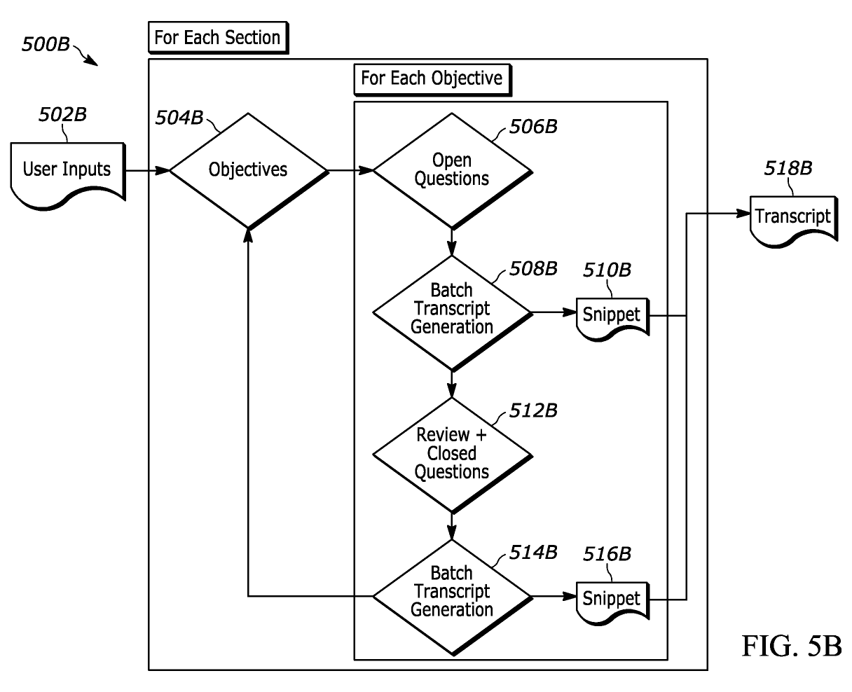

The processing unit 104 may input the deposition planning data 402 and transcript generation prompt 404 into the deposition simulation machine learning model 406. As described in more detail in connection with FIGS. 5A and 5B, deposition planning data 402 and transcript generation prompt 404 may be a single set of inputs simultaneously input into the deposition simulation machine learning model 406 or a series of inputs sequentially input into the deposition simulation machine learning model 406 until the synthetic transcript 408 is fully generated.

As shown in FIG. 4, the processing unit 104 may determine selection metrics 410 based on the synthetic deposition transcript 408. For example, in embodiments where the selection metric is based on a relevance score, the processing unit 104 may calculate respective relevance scores for at least a portion of the set of workspace objects 103. For example, the relevance score may indicate a degree of semantic similarity between text of the synthetic deposition transcript 408 and the text and/or other data associated with the workspace objects 103. In some embodiments, in addition to generating an overall relevance score for the workspace objects 103, the processing unit 104 may calculate respective relevance scores for component portions of the synthetic deposition transcript (e.g., portions that relate to a specific deposition objective).

In some embodiments, the processing unit 104 may use the deposition analysis ML model 108 as described herein to generate the selection metrics 410. For example, the processing unit 104 may analyze the synthetic transcripts 408 one or multiple times with the deposition analysis ML model 108 and document the frequency with which each of the workspace objects 103 are used to generate a response 114. The processing unit 104 may then use the frequency as the selection metrics 410.

As illustrated, the processing unit 104 may execute a selection module 414 to analyze the selection metrics 410 and select relevant objects 412 from among the workspace objects 103 stored in the data store 120. The relevant objects 412 may include fact objects, electronic document objects, and/or other data objects of the workspace 102 as described herein. To perform the selection, the selection module 414 may determine one or more constraints on the number of objects that can be selected such a cache characteristics 416 shown in FIG. 4. As one example, the selection module 414 may determine the amount of allocatable space within the cache 420 of the client device 122 as the cache characteristics 416. For example, the processing unit 104 may send a request to the client device 122 for the client device 122 to transmit back the amount of allocatable space available in the cache 420 for storage of the relevant objects 412. Once identified, the processing unit 104 may use the cache characteristics 416 to define a maximum size of the collection of objects selected as the relevant objects 412.

In some embodiments, the processing unit 104 may determine a subset of the set of workspace objects 103 that are mandatory to store in the cache 420. The mandatory subset of the set of workspace objects 103 may be defined by the user and/or be pre-defined documents that are of particular importance (e.g., a complaint, a pleading, a set of interrogatories, etc.). In some embodiments, the mandatory workspace objects provide background material related to the future deposition event. For example, the mandatory objects may include objects that define key people or entities relevant to the matter or specific electronic documents noted in the deposition planning data 402. In these embodiments, the processing unit 104 may determine a size of the mandatory workspace objects and reduce the amount of allocatable space available in the cache 420 in accordance therewith.

In some embodiments, to allocate the remaining cache space, the selection module 414 may generate rankings for the set of workspace objects according to the selection metrics 410 and select, as the relevant objects 412, a subset of the set of workspace objects 103 that fill the allocatable space of the cache 420 according to space filling criteria. The space filling criteria may consider one or more of the rankings, the plurality of deposition objectives, and respective sizes of the set of workspace objects 103 to maximize the space filled and relevancy of the selected ones of the relevant objects 412.

In some embodiments, the rankings may include an ordered listing of all the workspace objects 103 based on the selection metrics 410 (e.g., the relevancy score or frequency determination described above). In these embodiments, the space filling criteria may direct the selection module 414 to select the relevant objects 412 in ranked order until the selected relevant objects 412 would fill the allocatable space of the cache 420 or any remaining portions of the allocatable space would be too small to accommodate another one of the workspace objects 103.

Additionally or alternatively, the selection module 414 may rank the workspace objects 103 using the selection metrics 410 in groups or buckets that relate to each separate objectives described in the deposition planning data 402. In these embodiments, the space filling criteria may direct the processing unit 104 to select the relevant objects 412 by iteratively taking the highest ranking non-selected object from each group or bucket until the selected relevant objects 412 would fill the allocatable space of the cache 420 or any remaining portions of the allocatable space would be too small to accommodate another one of the workspace objects 103. In some embodiments, the objectives may also be ranked so that the processing unit 104 can prioritize selection of the workspace objects 103 associated with higher ranking objectives. It should be appreciated that other space filling criteria and filling algorithms known in the art may be used to maximize both the relevancy of the relevant objects 412 to the planned deposition event and the amount of the allocatable space that is filled.

In some embodiments, the processing unit 104 may compress or otherwise limit the size of the relevant objects 412 before being stored in the cache 420. For example, where the relevant objects 412 include electronic document objects, the processing unit 104 may remove extraneous portions of the documents such as headers footer, images, etc. Furthermore, the processing unit 104 may be configured to use the selection metrics 410, the synthetic transcript 408, and/or the objectives in the deposition planning data 402 to extract key relevant portions of the relevant objects 412 to save into the cache 420. For example, the processing unit 104 may extract a key page or paragraph from a large electronic document to save into the cache 420.

After the selection module 414 selects the set of relevant objects 412 to include in the cache 420, the processing unit 104 may then transmit the relevant objects 412 to the client device 122 for storage in the cache 420. As a result, the relevant objects 412 are accessible by the client device 122 during the future deposition event and can be utilized to provide real-time guidance on how to conduct the deposition without needing network access to the workspace 102.

With reference now to FIG. 5A a flow diagram of a method 500A for generating the synthetic transcript 408 with the deposition simulation machine learning model 406 is shown. In particular, the method 500A depicts an iterative process of providing multiple inputs to the deposition simulation machine learning model 406 to generate component text snippets of the synthetic transcript 408. In some embodiments, the synthetic transcript includes generated text simulating different defined persona roles (e.g., questioning attorney, defending attorney, deponent or witness, etc.) in furtherance of the deposition objectives in the deposition planning data 402.

At block 502A, the method 500A includes the processing unit 104 generating a set of inputs for the deposition simulation machine learning model 406. In particular, the processing unit 104 may segment the deposition planning data 402 to identify distinct deposition objectives and related transcript generation prompts 404. Then, at block 504A, the method 500A includes the processing unit 104 selecting a first objective of the identified objectives to simulate via the deposition simulation machine learning model 406.

When simulating a portion of the deposition related to a deposition objective, the processing unit 104 may iteratively generate text for the different persona roles via respective prompts to the deposition simulation machine learning model 406. For example, at block 506A, the method 500A includes the processing unit 104 inputting an attorney question generating prompt that relates to the first selected objective from block 504A to the deposition simulation machine learning model 406 to generate an attorney question text snippet 508A. The attorney question generating prompt may include instructions that direct the deposition simulation machine learning model 406 to generate a first question related to the selected objective and additional instructions that define one or multiple personality characteristics of the questioning attorney (e.g., combative, calm, analytical, deliberate, etc.).

At block 510A, the method 500A may include the processing unit 104 inputting the attorney question text snippet 508A and a defending attorney prompt that relates to the first selected objective from block 504A to the deposition simulation machine learning model 406 to generate a defending attorney text snippet 512A. The defending attorney prompt may include instructions that direct the deposition simulation machine learning model 406 to generate a response to the first question related to the selected objective and the attorney question text snippet 508A. For example, the defending attorney prompt may include the objection rules as described herein and the defending attorney text snippet 512A may include an objection to the attorney question text snippet 508A when the attorney question text snippet 508A meet one or more of the objection rules. In some embodiments, the defending attorney text snippet 512A may be a null output with no text such as when the deposition simulation machine learning model 406 determines that the defending attorney would not provide a response to the attorney question text snippet 508A. The defending attorney prompt may also include instructions that define one or multiple personality characteristics of the defending attorney (e.g., combative, calm, analytical, deliberate, etc.).

At block 514A, the method 500A may include the processing unit 104 inputting the defending attorney text snippet 512A and a witness prompt that relates to the first selected objective from block 504A to the deposition simulation machine learning model 406 to generate a witness text snippet 516A. Though not shown in FIG. 5A, the processing unit 104 may also input the attorney question text snippet 508A into the deposition simulation machine learning model 406 at block 514A so that the deposition simulation machine learning model 406 has the full context of the prior generated text needed to generate the witness text snippet 516A. Alternatively, in some embodiments, the defending attorney text snippet 512A may include the attorney question text snippet 508A or a restatement thereof generated by the deposition simulation machine learning model 406.

The witness prompt may include instructions that direct the deposition simulation machine learning model 406 to generate a response to the first question related to the selected objective, the attorney question text snippet 508A, and the defending attorney text snippet 512A. For example, the witness prompt may direct the deposition simulation machine learning model 406 to provide an answer to the attorney question text snippet 508A or to not answer where the defending attorney text snippet 512A directs the witness to not answer the asked question. In some embodiments, data associated with an entity object corresponding to the deposed witness is also input to the deposition simulation machine learning model 406 to define the universe of knowledge the witness is known to have based on an analysis of the corpus of documents. The witness prompt may also include instructions that define one or multiple personality characteristics of the witness (e.g., combative, calm, analytical, deliberate, etc.).

At block 518A, the method 500A may include the processing unit 104 inputting the snippet 516A and an evaluation prompt that relates to the first selected objective from block 504A to the deposition simulation machine learning model 406. Though not shown in FIG. 5A, the processing unit 104 may also input the attorney question text snippet 508A and the defending attorney text snippet 512A into the deposition simulation machine learning model 406 at block 518A such that the deposition simulation machine learning model 406 has the full context of the previously simulated portions of the deposition to perform the evaluation. Alternatively, in some embodiments, the defending attorney text snippet 516A may include the attorney question text snippet 508A and the defending attorney text snippet 512A or restatements thereof generated by the deposition simulation machine learning model 406.

The evaluation prompt may include instructions that direct the deposition simulation machine learning model 406 to determine whether the input snippets satisfy the first selected objective from block 504A. If the deposition simulation machine learning model 406 determines that the objective has not been satisfied, the method 500A may include repeating blocks 506A, 510A, 514A, and 518A until the deposition simulation machine learning model 406 determines that the objective has been met. As shown in FIG. 5A, when repeating the blocks 506A, 510A, 514A, and 518A, the method 500A may include the processing unit 104 inputting a combined text snippet 520A into the deposition simulation machine learning model 406 with the attorney question generating prompt such that the deposition simulation machine learning model 406 is provided the full context associated with the current deposition objective when repeating blocks 506A, 510A, 514A, and 518A. Furthermore, it should be appreciated that the processing unit 104 may include the full text of the conversation built up through repeated execution of blocks 506A, 510A, 514A, and 518A as inputs for each successive execution of the deposition simulation machine learning model 406 until the deposition simulation machine learning model 406 determines, at block 518A, that the objective is met.

On the other hand, if at block 522A the deposition simulation machine learning model 406 determines that the current deposition objective is met, the processing unit 104 may determine if there are any remaining unsimulated deposition objectives. If there are additional deposition objectives to simulate, the processing unit 104 may then return to block 504A to select a next objective from the deposition planning data 402. If there are no remaining deposition objectives to simulate, then at block 524A, the method 500A may include combining all the generated text snippets together to from the synthetic transcript 408 once all of the objectives have been met. It should be appreciated that the sections of the synthetic transcript 408 related to each objective may be generated sequentially or in parallel. For example, in some embodiments, the processing unit 104 may combine each of the generated text snippets together to generate the synthetic transcript 408. In some embodiments, as each snippet is generated, the processing unit 104 may insert the new snippet into an appropriate location within a current version of the synthetic transcript such that the synthetic transcript 408 is complete once the processing unit 104 determines that every objective is met. In other embodiments, the processing unit 104 may wait to combine the snippets into the synthetic transcript 408 until the processing unit 104 determines that every objective is met (e.g., to facilitate parallel combination of the text snippets related to each of the objectives).

With reference now to FIG. 5B a flow diagram of a method 500B for generating the synthetic transcript 408 with the deposition simulation machine learning model 406 is shown. In particular, the method 500B depicts an iterative process providing multiple inputs to the deposition simulation machine learning model 406 to generate component text snippets of the synthetic transcript 408that relate to the deposition objectives in the deposition planning data 402. For example, these text sections may be generated by the deposition simulation machine learning model 406 from hierarchical instructions to generate questions or response of different types related to the objectives without needing to simulate specific persona roles as with the method 500A.

At block 502B, the method 500B includes the processing unit 104 generating a set of inputs for the deposition simulation machine learning model 406. In particular, the processing unit 104 segments the deposition planning data 402 to identify distinct deposition objectives and related transcript generation prompts 404. Then, at block 504B, the method 500A includes the processing unit 104 selecting a first objective of the identified objectives for which to generate one or more text snippets.

For example, at blocks 506B and 508B, the method 500B may include the processing unit 104 directing the deposition simulation machine learning model 406 to generate a first text snippet 510B batch of open-type questions (e.g., open-ended questions that do not solicit a specific answer or refer to a specific document) and responses related to the first objective. Then, at blocks 512B and 514B the method 500B may include the processing unit 104 directing the deposition simulation machine learning model 406 to generate a second text snippet 516B batch of closed type questions (e.g., questions that try to solicit a specific answer or reference a specific document) and responses related to the first objective. In some embodiments, the method 500B may include, at block 512B, the deposition simulation machine learning model 406 may review the first text snippet 510B when generating the text snippet 516B so that the second text snippet 516B does not cover duplicate material asked and answered by the first text snippet 510B. It should be appreciated that in some embodiments, the batch of open type questions may be generated after the batch of closed type questions.

As shown in FIG. 5B, the method 500B may repeat blocks 504B, 506B, 512B, and 514B, until all the objectives in the deposition planning data 402 have been met. Although not depicted, techniques associated with the below-described plan tracking module 718 may be implemented during the method 500B to track progress towards completion of all of the deposition objectives. Then, at block 518B the method 500B may include combining all the text snippets generated from the repeating of blocks 504B, 506B, 512B, and 514B into the synthetic deposition transcript 408.

As described above, the processing unit 104 may then analyze the synthetic deposition transcript 408 to identify objects within the workspace that are relevant to the simulated deposition such that a local cache of a computing device used during the upcoming deposition is filled with the objects that are most likely to relate to upcoming deposition. For example, the processing unit 104 may define a relevancy metric based on the synthetic transcript 408 and/or component portions thereof. As a result, the computing device is able to provide real-time guidance based on local data without the introduction of network delays to obtain the relevant documentation on which the guidance is based.

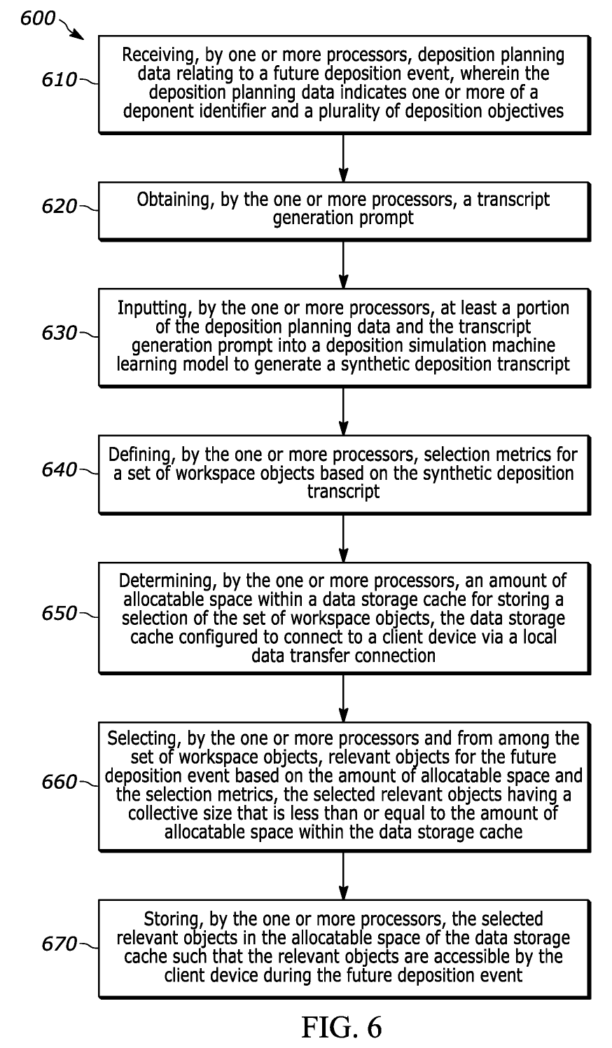

FIG. 6 shows a computer-implemented method 600 for using the deposition simulation machine learning model 406 to generate the synthetic transcript 408 and using the synthetic transcript 408 to select the relevant objects 412. The method 600 may be performed by the processing unit 104 executing instructions stored on the memory unit 106 to support the various modules described herein that are executed within the workspace 102.

At block 610, the method 600 includes receiving, by one or more processors, deposition planning data (e.g., deposition planning data 402) relating to a future deposition event. The deposition planning data indicates one or more of a deponent identifier and a plurality of deposition objectives.

At block 620, the method 600 includes obtaining, by the one or more processors, a transcript generation prompt (e.g., transcript generation prompt 404).

At block 630, the method 600 includes inputting, by the one or more processors, at least a portion of the deposition planning data and the transcript generation prompt into a deposition simulation machine learning model (e.g., deposition simulation machine learning model 406) to generate a synthetic deposition transcript (e.g., synthetic transcript 408).

At block 640, the method 600 includes defining, by the one or more processors, selection metrics (e.g., selection metrics 410) for a set of workspace objects (e.g., workspace objects 103) based on the synthetic deposition transcript. In some embodiments, defining the selection metrics includes determining, by the one or more processors and based on the synthetic deposition transcript, a respective relevance score for at least a portion of the set of workspace objects to use as the selection metrics. The respective relevance score indicates one or more of: a number of portions of the synthetic deposition transcript that are relevant to the associated one of the set of workspace objects; or a degree to which the set of workspace objects are relevant to portions of the synthetic deposition transcript. The set of objects may include one or more of fact objects and electronic document objects.

At block 650, the method 600 includes determining, by the one or more processors, an amount of allocatable space within a data storage cache (e.g., cache 420) for storing a selection of the set of workspace objects. The data storage cache is configured to connect to a client device (e.g., client device 122) via a local data transfer connection. The local data transfer connection includes one or more of an external wired connection, an external local area wireless connection, and an internal connection of the client device.

At block 660, the method 600 includes selecting, by the one or more processors and from among the set of workspace objects, relevant objects (e.g., relevant objects 412) for the future deposition event based on the amount of allocatable space and the selection metrics. The selected relevant objects have a collective size that is less than or equal to the amount of allocatable space within the data storage cache.

At block 670, the method 600 includes storing, by the one or more processors, the selected relevant objects in the allocatable space of the data storage cache such that the relevant objects are accessible by the client device during the future deposition event.

In some embodiments, at least a portion of the deposition planning data input into the deposition simulation machine learning model includes the plurality of deposition objectives. In these embodiments, the transcript generation prompt includes instructions that direct the deposition simulation machine learning model to synthetically simulate the future deposition event in a manner that addresses the plurality of deposition objectives and generate the synthetic deposition transcript as a transcript of the synthetic simulation. Furthermore, the transcript generation prompt may include instructions that direct the deposition simulation machine learning model to generate the synthetic deposition transcript by: iteratively generating text snippets for different persona roles relative to each of the deposition objectives, the different persona roles including one or more of a questioning attorney, a defending attorney, or a deponent; and combining the text snippets into the synthetic deposition transcript. Additionally or alternatively, the transcript generation prompt may include instructions that direct the deposition simulation machine learning model to generate text snippets for the different persona roles based on different personality characteristics assigned to the different persona roles.

Additionally or alternatively, the transcript generation prompt may include instructions that direct the deposition simulation machine learning model to generate the synthetic deposition transcript by: generating a plurality of text sections that relate to the deposition objectives, wherein the plurality of text sections include text related to one or more questions and responses thereto; and combining the plurality of text sections into the synthetic deposition transcript.

In some embodiments, a deposition objective of the plurality of deposition objectives relates to an object of the set of workspace objects. In these embodiments, the method 600 may include retrieving the related object and inputting the related object into the deposition simulation machine learning model with the at least a portion of the deposition planning data and the transcript generation prompt.

In some embodiments, selecting the relevant objects based on the amount of allocatable space and the selection metrics includes: generating, by the one or more processors, rankings for the set of workspace objects according to the selection metrics; and selecting, by the one or more processors and as the relevant objects, a subset of the set of workspace objects that fill the allocatable space of the data storage cache according to a space filling criteria that considers one or more of the rankings, the plurality of deposition objectives, and respective sizes of the set of workspace objects.

In some embodiments, the methods 600 includes determining, by the one or more processors, a mandatory subset of the set of workspace objects; determining, by the one or more processors, a size of the mandatory subset of the set of workspace objects; determining, by the one or more processors, the amount of allocatable space within the data storage cache for storing the selection of the set of workspace objects to account for the size of the mandatory subset of the set of workspace objects; and storing, by the one or more processors, the mandatory subset of the set of workspace objects in the allocatable space of the data storage cache. The mandatory subset of the set of workspace objects may be defined by received user input, and include one or more or the workspace objects that provide background material related to the future deposition event.

### ANALYZING A DEPOSITION EVENT USING A DEPOSITION PLAN

With reference now to FIG. 7A, another computing environment 700 is shown. In general, the computing environment 700 may include any of the computing environments 100A-D described herein in connection with FIGS. 1A-D that execute the deposition analysis ML model 108 on either the workspace 102 or the client device 122. As shown in FIG. 7A, the computing environment 700 may include a computer system 702 (e.g., the workspace 102, the client device 122, or another similar device).

The computer system 702 may include a processing unit 704 and a memory unit 706 that implements the computing environment 700. More particularly, the processing unit 704 and the memory unit 706 may comprise the processing unit 104 and memory unit 106 of the workspace 102 as described herein or a processing unit and memory unit of the client device 122. Specifically, the operations of the computer system 702 as described herein may be performed by the processing unit 104 of the workspace 102 and/or the client device 122. The processing unit 704 includes one or more processors, each of which may be a programmable microprocessor that executes software instructions stored in memory unit 706 to execute some or all of the functions of the computer system 702 as described herein.

The processing unit 704 may include one or more graphics processing units (GPUs) and/or one or more central processing units (CPUs), for example. Alternatively, or in addition, one or more processors in processing unit 704 may be other types of processors (e.g., application-specific integrated circuits (ASICs), field-programmable gate arrays (FPGAs), etc.), and some of the functionality of computer system 702 as described herein may instead be implemented in hardware. Memory unit 706 may include one or more volatile and/or non-volatile memories or similar computer readable media. Any suitable memory type or types may be included in memory unit 706, such as read-only memory (ROM) and/or random-access memory (RAM), flash memory, a solid-state drive (SSD), a hard disk drive (HDD), and so on. Collectively, memory unit 706 may store one or more software applications, the data received/used by those applications, and the data output/generated by those applications.

In particular, memory unit 706 stores the software that, when executed by processing unit 704, performs various functions of the computing environment computing environment 700 related to execution of a deposition analysis ML model 708 to analyze deposition data 710, a deposition plan 711, and relevant objects 712 to generate a response 714 to the deposition data 710 as directed by a deposition analysis prompt 716. As discussed in more detail below, in some embodiments, the deposition analysis ML model 708 may generate the response 714 without reference to the relevant objects 712 (e.g., the relevant objects 712 may not be provided as an input to the deposition analysis ML model 708). In general, the deposition analysis ML model 708 comprises a set of interconnected nodes, layers, trained parameter values (e.g., multiplicative weights, additive bias, etc.), etc. similar to the deposition analysis ML model 108 as described above.

Except as specifically noted below, the deposition analysis ML model 708, the deposition data 710, the relevant objects 712, the response 714, and the deposition analysis prompt 716 include similar features, model data, and/or components to the deposition analysis ML model 108, the deposition data 110, the relevant objects 112, the response 114, and the deposition analysis prompt 116 described elsewhere herein. Furthermore, the computer system 702 may include a user interface 717 for displaying the response 114. The user interface 717 may include the user interface window 200 as described above.

The deposition plan 711 may include one or more of objectives for the active deposition event and/or questions to be asked during the active deposition event being analyzed using the computing environment 700. The objective may include the objectives included in the deposition planning data 402 and the questions may include one or more of the questions included in the synthetic transcript 408 as discussed above in connection with FIGS. 4-6.

Furthermore, as shown in FIG. 7A, the computer system 702 may include a plan tracking module 718 that monitors and tracks progress of the deposition event with respect to the one or more objectives and the questions to be asked of the deposition plan 711. In particular, the plan tracking module 718 may record the progress of the deposition event in a log file 720. The plan tracking module 718 may be included in the computer system 702 in cases where the context window of the deposition analysis ML model 708 may not be large enough to accommodate the full history of the deposition event. However, the plan tracking module 718 may also be used regardless of the context window size of the deposition analysis ML model 708. The log file 720 may also be input into the deposition analysis ML model 708 so that the deposition analysis ML model 708 may identify objectives and questions in the deposition plan 711 that prior portions of the deposition event have already sufficiently addressed. In some embodiments, the deposition analysis ML model 708 may be able to monitor and track the totality of the deposition event and the deposition data 710 within the context window of the deposition analysis ML model 708 (e.g., the total history of the deposition event is input as the deposition data 710).

With reference now to FIG. 7B, a sequence diagram of an example process 750 for generating the response 714 using the computing environment 700 of FIG. 7A is shown.

At operation 752, the processing unit 704 receives the deposition data 710. In particular, the processing unit 704 may receive the deposition data 710 from the external source 124 described above in connection with FIGS. 1A-1D, from the client device 122 in embodiment where the computer system 702 is distinct from the client device 122, or from a component of the client device 122 (e.g., as audio input via a microphone, video input via a camera, typed input via a keyboard, etc.) in embodiments where the computer system 702 comprises the client device 122. In embodiments where the deposition data 710 include audio or video data the processing unit 704 may convert the deposition data 710 to text data for further processing by the deposition analysis ML model 708. The processing unit 704 may also receive the deposition data 710 in the sequential and real-time manner described above in connection with the deposition data 110. Furthermore the processing unit 704 may be configured to segment the deposition data 710 for processing by the deposition analysis ML model 708 in any manner described herein.

At operation 754, the processing unit 704 obtains the deposition plan 711, the relevant objects 712, the deposition analysis prompt 716, and the log file 720 from the memory unit 706. It should be appreciated that the processing unit 704 may obtain the relevant objects 712, the deposition analysis prompt 716, and the log file 720 from alternative data storage components electrically coupled to the processing unit 704 (e.g., the cache 420 of the client device 122, the data store 120, etc.).

At operation 756, the processing unit 704 inputs the obtained deposition position plan 711, relevant objects 712, deposition analysis prompt 716, and log file 720 into the deposition analysis ML model 708. The relevant objects 712, the deposition data 710, the deposition analysis prompt 716, and the log file 720 may be a single set of inputs simultaneously input into the deposition analysis ML model 708 or a sequenced set of inputs sequentially input into the deposition analysis ML model 708. For example, the processing unit 704 may combine the deposition data 710, the deposition plan 711, the relevant objects 712, and the log file 720 with the deposition analysis prompt 716 by appending the raw text of the deposition data 710, the deposition plan 711, the relevant objects 112, and the log file 720 together with the deposition analysis prompt 716 or by appending a reference marker for the relevant objects 712 to the deposition analysis prompt 716 that the deposition analysis ML model 708 may use to recall the relevant objects 712 from a data store (e.g., data store 120) or a local cache (e.g., cache 420).

At operation 758, the deposition analysis ML model 108 generates the response 714 using the obtained deposition position plan 711, relevant objects 712, deposition analysis prompt 716, and log file 720 as inputs. In general, the deposition analysis ML model 708 may analyze the deposition data 710, the deposition plan 711, the relevant objects 712, and the log file 720 as directed by the deposition analysis prompt 716 to generate the response 714.

The deposition analysis prompt 716 is configured to control how the deposition analysis ML model 708 analyzes content of the deposition data 710, the deposition plan 711, the relevant objects 712, and the log file 720 to generate the response 714. The deposition analysis prompt 716 may include some or all of the instructions described above with respect to deposition analysis prompt 116. In particular, the deposition analysis prompt 716 may include the rules from the deposition analysis prompt 116 relating to analyzing or otherwise using the relevant objects 112 to generate the response 114. As such, the response 714 may include the content of the response 114 used to guide future portions of the deposition event as described herein and as shown in more detail in connection with FIGS. 2A-2K.

The deposition analysis prompt 716 may also include additional rules or instructions relating to processing of the deposition data 710 based on the deposition plan 711 and/or the log file 720. In some embodiments, the deposition analysis prompt 716 may omit the instructions or rules relating to analysis of the relevant objects 712 and the processing unit 704 may refrain from obtaining and inputting the relevant objects 712 into the deposition analysis ML model 708. In particular, a user may configure the computing environment 700 and the deposition analysis ML model 708 only to analyze the deposition event with respect to the deposition data 710, the deposition plan 711, and the log file 720 and not the relevant objects 712. For example, the user may wish to disable fact checking features of the deposition analysis ML model 708 with respect to the relevant objects 712. Additionally, or alternatively, the fact checking and other features relying on analysis of the relevant objects 712 may be performed by a sperate ML model distinct from the deposition analysis ML model 708 (e.g., the deposition analysis ML model 108). In these embodiments, the response 714 may include only analysis results of the deposition data 710 relating to the deposition plan 711 and the log file 720 as discussed below. However, where analysis of the relevant objects 712 is performed by a distinct ML model, those results (e.g., the response 114) may be combined with the response 714 for presentation to the user on the user interface 717.

The deposition analysis prompt 716 may control how deposition analysis ML model 708 analyzes the deposition data 710 with respect to the deposition plan 711 to generate the response 714. For example, the instruction in the deposition analysis prompt 716 may direct the deposition analysis ML model 708 to include in the response 714 instruction or other indications that direct the user of the computer system 702 to conform future aspects of the deposition event to the deposition plan 711 or to modify the deposition plan 711 based on events identified in the deposition data 710.

For example, the deposition analysis prompt 716 may include instructions that direct the deposition analysis ML model 708 to compare the deposition data 710 to the deposition plan 711 and include, in the response 714, one or more instructions to ask the questions included in the deposition plan 711. Additionally or alternatively, the deposition analysis prompt 716 may include instructions that direct the deposition analysis ML model 708 to (i) determine that the deposition data 710 satisfies one of the objectives or answers one of the questions in the deposition plan 711 and (ii) include, in the response 714, at least one of an indication of the satisfied objective or answered question or an indication of a next objective or question selected from the deposition plan 711.

Furthermore, the deposition analysis prompt 716 may includes instructions that direct the deposition analysis ML model 708 to compare the deposition data 710 to the deposition plan 711 and include, in the response 714, a modification or an update to the deposition plan 711 based on information included in the deposition data 710. The modification or update to the deposition plan 711 may include changes to an order of the questions in the deposition plan 711, recommendations to not ask one or more of the questions included in the deposition plan 711, and/or recommendations to ask new questions not included in the deposition plan 711.

Additionally or alternatively, the deposition analysis prompt 716 includes analysis rules that direct the deposition analysis ML model 708 to identify an unexpected response by comparing the deposition data 710 to the deposition plan 711 and to include an indication of the unexpected response in the response to the deposition data. For example, an unexpected response may include a witness denying a known fact or providing new information that contradicts a known fact or document. In these embodiments, the deposition analysis prompt 716 may include question generating rules that direct the deposition analysis ML model 708 to generate follow up questions to include in the response 714 based on the unexpected responses.

Furthermore, the deposition analysis prompt 716 may include instructions that direct operation of the deposition analysis ML model 708 with respect to the log file 720 when generating the response 714. For example, the deposition analysis prompt 716 may include instructions that direct the deposition analysis ML model 708 to include, in the response 714, an indication that the one or more of the questions contained in the deposition plan 711 were asked in the current portion of the deposition data 710 being processed. In response to this indication, the plan tracking module 718 may update the log file 720 to indicate that the one or more of the questions have been asked.

Furthermore, the deposition analysis prompt 716 may include instructions that direct the deposition analysis ML model 708 to generate the response 714 by analyzing the deposition data 710 with respect to portions of the deposition plan 711 that the log file 720 indicates as remaining unaddressed. The unaddressed portions of the deposition plan 711 may include one or more unanswered questions or unfulfilled objectives. In these embodiments, the deposition analysis prompt 716 may also include instructions that direct the deposition analysis ML model 708 to detect that the deposition data 710 includes one or more portions that answer at least one of the unanswered questions or fulfill at least one of the unfulfilled objective and include, in the response 714, an indication that the unanswered questions have been answered or that the unfulfilled objectives have been fulfilled.

At operation 760, the processing unit 704 causes the user interface 717 to display the response 714. For example, the processing unit 704 may send the response 714 to the user interface 717, which may display the content of the response 714 in a user interface window (e.g., the user interface window 200). In particular, the various reminders, questions to ask etc. relating to the deposition plan 711 may be displayed in the user interface window 200 as a new section of the user interface window 200, within the response section 204, as a pop-up window etc. Furthermore, in embodiments where the response 714 includes features of or is combined with the response 114 as described above, the processing unit 704 may cause the user interface 717 to display any of the sections or portions of the user interface window 200 described above in connection with FIGS. 2A-2K.

In embodiments where the computer system 702 is the client device 122 and the relevant objects 712 used as inputs to the deposition analysis ML model 708 include the relevant objects 412 preloaded into the cache 420 as shown and described in connection with FIGS. 4-6 above, the processing unit 704 may delay displaying portions of the response 714 that indicate material in the deposition data 710 is new material (e.g., the first indicator 214A and fourth status identifier 208D as shown in FIG. 2D). In particular, in embodiments where the response 714 indicates that a witness statement or other portions of the deposition data 710 is likely new material (e.g., not related to or referenced by the relevant objects 712), the processing unit 704 may remotely connect to the workspace 102 and verify that the portion of the deposition data 710 identified as new does not relate to any one of the complete collection of the workspace objects 103as stored in the data store 120. For example, the processing unit 104 may receive the allegedly new portion of the deposition data 710 and analyze that portion with the deposition analysis ML model 108 as described herein to verify that the new portion is actually new. Furthermore, while the computer system 702 is awaiting verification from the processing unit 104, the processing unit 704 may cause other portions of the response 714 and/or recommended delay questions to be displayed on the user interface 717.

At operation 762, the processing unit 704 inputs the response 714 to the plan tracking module 718 which, at operation 764, updates the log file 720 as saved in the memory unit 706 to reflect the response 714. For example, the plan tracking module 718 may update the log file 720 to indicate which of the questions in the deposition plan 711 have been answered and which of the objectives have been fulfilled. To perform this update, the plan tracking module 718 may use the indications of the answered questions, addressed objectives, etc. generated by the deposition analysis ML model 708 and included in the response 714.

In some embodiments, the plan tracking module 718 may include a plan tracking ML model with parameters and features similar to those of the other ML models described herein. In these embodiments, the processing unit 704 may input the deposition data 710, the log file 720, and a plan tracking prompt into a plan tracking ML model to generate the updated log file 720. In particular, the plan tracking prompt may include the rules described above of the deposition analysis prompt 716 that relate to monitoring and determining whether deposition data 710 answers questions or fulfills objectives noted in the deposition plan 711. Identifying the answered portions and addressed objectives using the plan tracking ML model instead of the deposition analysis ML model 708 frees up both processing resources and context window space for the deposition analysis ML model 708 to generate the recommendations related to the deposition plan 711 and/or analysis of the deposition data 710 relative to the relevant objects 712 as described herein.

As shown in FIG. 7B, following operations 762 and/or 764, the processing unit 704 may return to operation 752 to receive a next portion of the deposition data 710 if available.

It should be appreciated that the operations of the process 750 may be performed in any suitable order and/or in parallel.

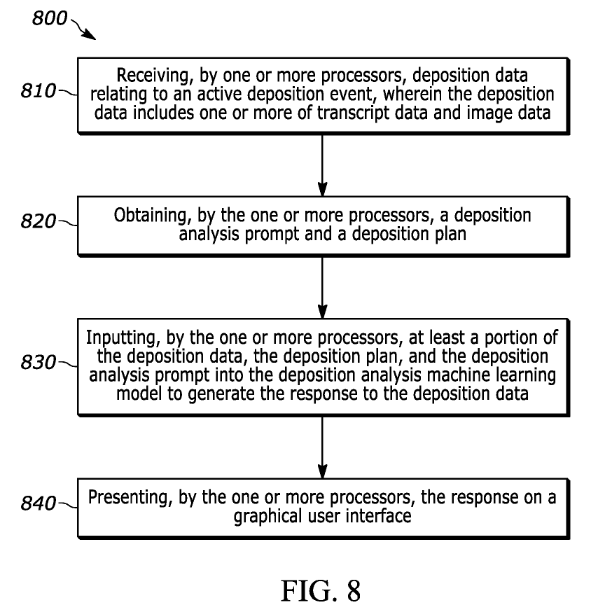

FIG. 8 shows a computer-implemented method 800 for using the deposition analysis ML model 708 to generate the response 714. The method 800 may be performed by the processing unit 704 executing instructions stored on the memory unit 706 to support the various modules described herein that are executed within the computer system 702.

At block 810, the method 800 includes receiving, by one or more processors, deposition data (e.g., deposition data 710) relating to an active deposition event. The deposition data includes one or more of transcript data and image data.

At block 820, the method 800 includes obtaining, by the one or more processors, a deposition analysis prompt (e.g., deposition analysis prompt 716) and a deposition plan (e.g., deposition plan 711). The deposition plan includes one or more of objectives for the active deposition event or questions to be asked during the active deposition event and the deposition analysis prompt is configured to control how a deposition analysis machine learning model (e.g., deposition analysis ML model 708) analyzes the deposition data with respect to the deposition plan to generate a response (e.g., response 714) to the deposition data.

At block 830, the method 800 includes inputting, by the one or more processors, at least a portion of the deposition data, the deposition plan, and the deposition analysis prompt into the deposition analysis machine learning model to generate the response to the deposition data.

At block 840, the method 800 includes presenting, by the one or more processors, the response on a graphical user interface (e.g., user interface 717).

In some embodiments, the method 800 includes recording, by the one or more processors and in a log file (e.g., log file 720), progress of the deposition event with respect to the one or more objectives and the questions to be asked based on the response.

In some embodiments, the deposition analysis prompt includes instructions that direct the deposition analysis machine learning model to compare the deposition data to the deposition plan to detect that the deposition data includes indications of one or more of the questions to be asked during the deposition event. The deposition analysis prompt may also include instructions that direct the deposition analysis machine learning model to include, in the response, an indication that the one or more of the questions were asked. The method 800 may include updating, by the one or more processors, the log file to mark the one or more of the questions as asked in response to a plan tracking module receiving the response that includes the indication that the one or more of the questions were asked.

The method 800 may include inputting the log file into the deposition analysis machine learning model with the at least the portion of the deposition data, the deposition plan, and the deposition analysis prompt. The deposition analysis prompt may include instructions that direct the deposition analysis machine learning model to generate the response to the deposition data by analyzing the deposition data with respect to portions of the deposition plan that the log file indicates as remaining unaddressed. The unaddressed portions of the deposition plan may include one or more unanswered questions or unfulfilled objectives. The deposition analysis prompt may further include instructions that direct the deposition analysis machine learning model to detect that the deposition data includes one or more portions that answer at least one of the unanswered questions or fulfill at least one of the unfulfilled objective and include, in the response, an indication that the unanswered questions have been answered or that the unfulfilled objectives have been fulfilled.

The deposition analysis prompt may include instructions that direct the deposition analysis machine learning model to compare the deposition data to the deposition plan and include, in the response, one or more instructions to ask the questions included in the deposition plan. The deposition analysis prompt may also include instructions that direct the deposition analysis machine learning model to (i) determine that the deposition data satisfies one of the objectives or answers one of the questions and (ii) include, in the response, at least one of an indication of the satisfied objective or answered question or an indication of a next objective or question selected from the deposition plan.

The deposition analysis prompt may include instructions that direct the deposition analysis machine learning model to compare the deposition data to the deposition plan and include, in the response, a modification or an update to the deposition plan based on information included in the deposition data. The modification or update to the deposition plan may include changes to an order of the questions in the deposition plan. The modification or update to the deposition plan may also include recommendations to not ask one or more of the questions included in the deposition plan. The modification or update to the deposition plan may also include recommendations to ask new questions not included in the deposition plan.

The deposition analysis prompt may include analysis rules that direct the deposition analysis machine learning model to identify an unexpected response by comparing the deposition data to the deposition plan and to include an indication of the unexpected response in the response to the deposition data. The deposition analysis prompt may include question generating rules that direct the deposition analysis machine learning model to generate follow up questions to include in the response based on the unexpected responses.

### POST DEPOSITION EVENT FACT OBJECT UPDATING

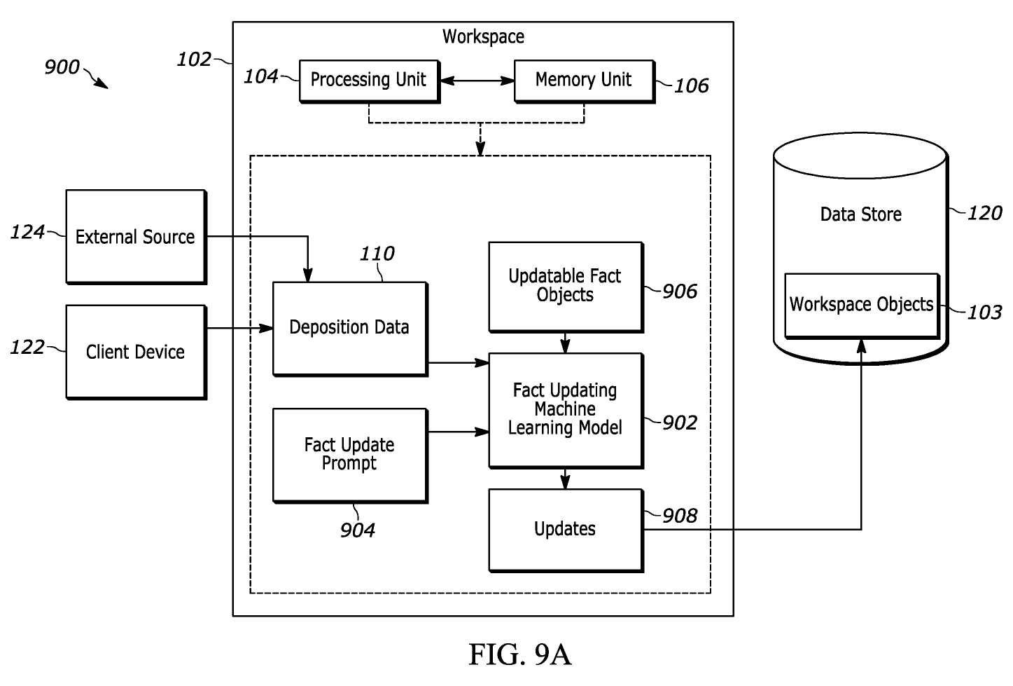

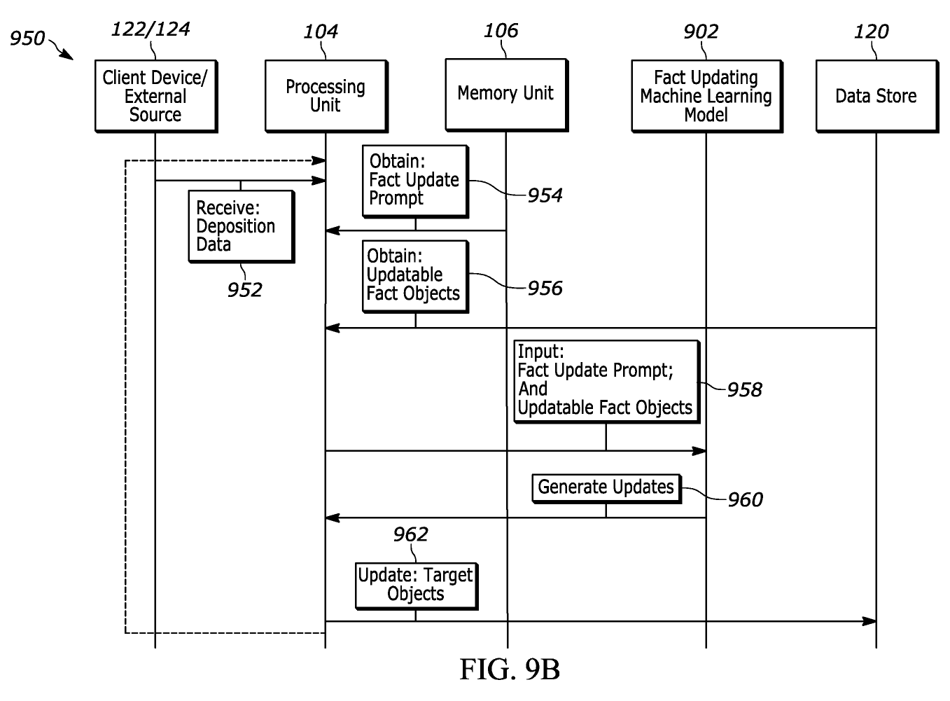

With reference now to FIG. 9A, another computing environment 900 is shown. The computing environment 900 may include portions of the computing environments 100A-D and 400 as described herein. For example, as shown in FIG. 9A, the computing environment 900 may include the workspace 102, the processing unit 104, the memory unit 106, the data store 120 and workspace objects 103 stored therein, the client device 122, and the external source 124. In general, the computing environment 900 may use the workspace 102 to generate updates 908 for the workspace objects 103 based on deposition data 110 as received from the client device 122 and/or the external source 124. In particular, the deposition data 110 may relate to one or more completed deposition events rather than a live input of an ongoing deposition event. The updated workspace objects 103 may include fact objects such as those described in U.S. Provisional application 63/719,260.

In particular, the memory unit 106 stores the software that, when executed by processing unit 104, performs various functions of the computing environment 900 related to execution of a fact updating ML model 902 to analyze deposition data 110 and updatable fact objects 906 to generate the updates 908 for existing fact objects of the workspace objects 103 as directed by a fact update prompt 904. The fact updating ML model 902 may comprise a set of interconnected nodes, layers, trained parameter values (e.g., multiplicative weights, additive bias, etc.), etc. similar to the other ML models as described above. Furthermore, the fact updating ML model 902 may include any of the LLM models described herein, where the operational differences of the ML model 902 are controlled by difference in the fact update prompt 904 as compared with other input prompts described herein (e.g., the deposition analysis prompt 116, transcript generation prompt 404, and deposition analysis prompt 716). It should be appreciated that in some embodiments, the fact updating ML model 902 may include non-LLM ML models and/or be substituted for a algorithm based process. For example, where an object in the workspace objects 103 includes Boolean field (e.g., a field to indicate that a witness has certified that a fact is true, that a document is accurate, etc.) the processing unit 104 may identify the associated object in the workspace objects 103 using search queries (e.g., the search queries 118A and/or 118B) and update the Boolean field without using an LLM..

Generating the updates 908 using the workspace 102 following the deposition event facilitates the local execution of the deposition analysis ML model 108 on the client device 122 as described herein. In particular, where the client device 122 operates the deposition analysis ML model 108 using the preloaded subset of relevant objects 412 described above, the client device 122 would not be configured to locally update all the workspace objects 103 during the deposition event because the preloaded subset of relevant objects 412 does not include every one of the workspace objects 103 that may need to be updated based on the deposition data 110. As such, the post deposition event updates process described below offload the updating of fact objects to the workspace 102 and the processing unit 104 so that processing resources of the client device 122 may be dedicated to the low latency local execution of the deposition analysis ML model 108.

With reference now to FIG. 9B, a sequence diagram of an example process 950 for generating the updates 908 using the computing environment 900 of FIG. 9A is shown.

At operation 952, the processing unit 104 receives the deposition data 110. In particular, the processing unit 104 may receive the deposition data 110 from the external source 124 described above in connection with FIGS. 1A-1D and/or from the client device 122. In embodiments where the deposition data 110 includes audio or video data the processing unit 104 may convert the deposition data 110 to text data for further processing by the fact updating ML model 902.

In some embodiments, the processing unit 104 may be configured to segment the deposition data 110 for processing by the ML model 902. For example, the processing unit 104 may segment the deposition data 110 as described above by identifying segmentation markers that include one or more of a change in speaker or a time pause between portions of the deposition data 110 that exceeds a preconfigured threshold. Additionally or alternatively, the processing unit 104 may segment the deposition data 110 by identifying segmentation markers that include one or more topic identifiers in the deposition data 110. For example, the topic identifies may sort the deposition data 110 into portions that relate to a common theme or to a particular objective (e.g., the deposition objectives in the deposition plan 711). The processing unit 104 may identify the topics within the deposition data 110 following the deposition event or the client device 122 may identify the topics as the deposition data 110 is being generated live during the deposition event (e.g., by using the deposition analysis ML model 108).

At operation 954, the processing unit 104 obtains the fact update prompt 904 from the memory unit 106. It should be appreciated that the processing unit 104 may obtain the fact update prompt 904 from alternative data storage components electrically coupled to the processing unit 104.

At operation 956, the processing unit 104 obtains the updatable fact objects 906 from the data store 120. The updatable fact objects 906 may include a subset of the workspace objects 103 that may be identified as being possibly relevant to and needing updates following the deposition event. The processing unit 104 may identify the updatable fact objects 906 using the deposition data 110 in any of the matters described herein by which the relevant objects 112 are identified, including by using the search queries 118A and 118B. For example, the processing unit 104 may generate one or more search queries (e.g., search queries 118A) based on the deposition data 110, query the data store 120 using the one or more search queries, and define the updatable fact objects 906 based on results of the query. In some embodiments, the processing unit 104 obtains a set of keywords or phrases (e.g., the search queries 118B) that are associated with respective ones of workspace objects 103 stored in the data store 120 and parses the deposition data 110 to identify matched keywords or phrases from the set of keywords or phrases that at least semantically match one or more portions of the deposition data 110. Then the processing unit 104 may define the updatable fact objects 906 as the fact objects in the data store 120 associated with the matched keywords or phrases.

In some embodiments, the processing unit 104 may define or retrieve the updatable fact objects 906 based on data generated by the client device 122 during the deposition event that produced the deposition data 110. For example, a deposition analysis machine learning model (e.g., the deposition analysis ML model 108) operating on the client device 122 during the deposition event may analyze the deposition data 110 as the deposition data 110 is being generated. As part of this analysis, the deposition analysis ML model operating on the client device 122 may generate identifiers for or otherwise flag one or more fact objects (e.g., the relevant objects 412) that are maintained in a cache (e.g., cache 420) of the client device 122 as related to the deposition data 110. The processing unit 104 may then use the identifiers or flags to obtain the updatable fact objects 906. For example, the processing unit 104 may obtain the updatable fact objects 906 from the data store 120 based on the identifiers generated by the deposition analysis ML model 108. Additionally or alternatively, the processing unit 104 may obtain the flagged fact objects from the cache of the client device 122 and define the flagged fact objects as the updatable fact objects 906.

In some embodiments, the processing unit 104 may define and/or obtain the updatable fact objects 906 relative to different segments of the deposition data 110. In particular, the different segments may be separately processed through the fact updating ML model 902 with the associated set of the updatable fact objects 906.

At operation 958, the processing unit 104 inputs the updatable fact objects 906, the deposition data 110, and the fact update prompt 904 into the fact updating ML model 902. The updatable fact objects 906, the deposition data 110, and the fact update prompt 904 may be a single set of inputs simultaneously input into the fact updating ML model 902 or a sequenced set of inputs sequentially input into the fact updating ML model 902. For example, the processing unit 104 may combine the deposition data 110 and the updatable fact objects 906 with the fact update prompt 904 by appending the raw text of the deposition data 110 and the updatable fact objects 906 together with the fact update prompt 904 or by appending a reference marker for the updatable fact objects 906 to the deposition analysis prompt 116 that the fact updating ML model 902 may use to recall the updatable fact objects 906 from the data store 120, a local cache of the workspace 102 and/or the cache (e.g., cache 420) of the client device 122.

At operation 960, the fact updating ML model 902 generates the updates 908 by analyzing content of the deposition data 110 and the updatable fact objects 906 as directed by the fact update prompt 904. In particular, the fact update prompt 904 may direct the fact updating ML model 902 to identify target objects from the updatable fact objects 906 for updating. The fact update prompt 904 may also direct the fact updating ML model 902 to extract or summarize the deposition data 110 to generate the updates 908 for the target objects within the data store 120.

In some embodiments, the fact update prompt 904 includes instructions that direct the fact update ML model 902 to compare text of the deposition data 110 to text of the updatable fact objects 906 and identify relevant portions of the deposition data 110 that supplement or contradict portions the updatable fact objects 906. The fact update prompt 904 may also instruct the fact updating ML model 902 to generate the updates 908 based on the relevant portions of the deposition data. Example relevant portions of the deposition data 110 may include witness statements in the deposition data 110 that indicate a different date, time, or location for an event; indicate the presence or involvement of new or different people in an event or plan; or otherwise present additional or different fact information that is conceptually related to one of the updatable fact objects 906. The fact updating ML model 902 may determine the conceptual relationship by comparing the text of the deposition data 110 to the text of the updatable fact objects 906 and determining that the text is semantically similar (e.g., within some threshold level of similarity). For example, the fact updating ML model 902 may assess whether text mentioning specific people, places, times, events, etc. are contextually equivalent to text of one of the updatable fact objects 906.

At operation 962, the processing unit 104 updates the target objects as stored in the data store 120 in accordance with the generated updates 908. For example, the processing unit 104 may replace or modify data fields of the target objects within the data store 120 to conform to the updates 908. In particular, the processing unit 104 may identify the data fields of the target objects associated with the generated updates 908 and modify the identified data fields. In some embodiments, the fact updating ML model 902 may generate identifiers for the target objects and/or the specific fields thereof that the processing unit 104 uses to push the updates 908 to the data store 120. In some embodiments, the updates 908 may include a complete replacement object for one of the workspace objects 103. In these embodiments, the processing unit 104 may overwrite the existing one of the workspace objects 103 with the new replacement object.

In some embodiments, the updates 908 may include replacement text or additional text for specific portions of the target fact objects. The specific portions may include particular fields of the target objects and/or the relevant portions that the fact updating ML model 902 identified as described above. In some embodiments, the generated updates 908 may include replacement text that summarizes the relevant portions of the deposition data 110 as well as the existing portions of the target objects related thereto. The replacement text may include a text summary of fact information that is know and consistent with both the deposition data 110 and the prior text of the target object. For example, where a witness indicates in the deposition data 110 that an event occurred at a different date or time from a date or time associated with that event in the target object, the replacement text for the target object may omit the date entirely.

However, in some embodiments, the generated updates 908 may include additional text for the target objects. The additional text may include a summary of the relevant portions of the deposition data 110 that the fact updating ML model 902 identified as described above. For example, in the case where the witness indicates in the deposition data 110 that the event occurred at a different date or time from the date or time associated with that event in the target object, the additional text for the target object may add the newly indicated date to the text of the target object by appending the additional text to a portion of the target object (e.g., to a portion of one field of the target object).

In some embodiments, the deposition data 110 may include fact information that is not conceptually related to (e.g., the fact updating ML model 902 does not find a sufficient semantically matching) one of the updatable fact objects 906. In these cases, the fact updating ML model 902 may output new facts that the processing unit 104 populates into respective data fields of one or more new fact objects of the workspace objects 103 based upon the new facts output by the fact updating ML model 902. To facilitate this new fact identification and output process, the fact update prompt 904 may includes instructions that direct the fact updating machine learning model to compare the deposition data 110 to text of the updatable fact objects 906 to identify first portions of the deposition data 110 that at least semantically match text in the updatable fact objects 906 for use in generating the updates 908 and second portions of the deposition data 110 that (1) include an identified fact and (2) fail to at least semantically match text in the set of relevant fact objects.

In some embodiments, the client device 122 may generate new fact objects or update fact objects stored in the cache 420 during the deposition event. In these embodiments, the processing unit 104 may process these updated and new fact objects as part of the general update process for the workspace objects 103. In particular, the processing unit 104 may exclude the copies of the updated one or more fact objects from the updatable fact objects 906 because those objects have already been updated by the client device 122. Furthermore, the processing unit 104 may replace copies of the updated one or more fact stored in the data store 120 with the updated one or more fact objects maintained in the cache of the client device 122 and store the one or more new fact objects in the data store 120. It should also be appreciated that the processing unit 104 may compare any new facts output by the fact updating ML model 902 to the new fact objects generated by the client device 122 and refrain from generating new fact objects for output facts that semantically match the new fact objects generated by the client device 122.

Alternatively, in some embodiments, the new fact objects and the updated fact objects from the client device 122 may be input into the fact updating ML model 902 and marked as not requiring further updates so that the fact updating ML model 902 may ignore text in the deposition data 110 that would otherwise cause the fact updating ML model 902 to generate an associated one of the updates 908 or a new fact.

As described above in connection with FIGS. 1A-3, the deposition analysis ML model 108 operating on the workspace 102 and/or the client device 122 may assess the veracity of a witness statement made during the deposition event. For example, the deposition analysis ML model 108 may determine that a fact in the relevant objects 112 conflicts with a statement or that the behavior assessment 132 (see FIG. 1D) of the witness indicates that the statement is likely untruthful. When these veracity determinations are made during a live deposition event, the client device 122 and/or processing unit 104 of the workspace 102 may generate and store a record of the veracity determinations in a corresponding cache or storage device (e.g., the cache 420, the data store 120, etc.). The processing unit 104 may input this record into the fact updating ML model 902 with the fact update prompt 904, the deposition data 110, and the updatable fact objects 906 at operation 958 so that the fact updating ML model 902 may further evaluate whether the veracity determination were likely correct or incorrect based on the updatable fact objects 906. In particular, the fact update prompt 904 may include instructions that direct the fact updating ML model 902 to compare the veracity determinations in the record to the updatable fact objects 906 to identify incorrect veracity determinations that are contradicted by the updatable fact objects 906. The processing unit 104 may then update parameters of the deposition analysis ML model 108 or the behavior classification ML model 128 based on the identified incorrect veracity determinations.

As shown in FIG. 9B, following operation 962, the processing unit 104 may return to the beginning of the process 950 to execute the operations thereof again. For example, the processing unit 104 may return to the operation 952 to receive additional deposition data 110 (e.g., data from another deposition event, data from other portions of the original deposition evet, etc.) Furthermore, in some embodiments, the processing unit 104 may return to other operations of the process besides the operation 952. For example, when the processing unit 104 segmented the deposition data 110 after receipt, the processing unit 104 may return to the operation 956 to obtain additional updatable fact objects 906 that are likely relevant to a next segment of the deposition data 110.

It should be appreciated that the operations of the process 950 may be performed in any suitable order and/or in parallel.

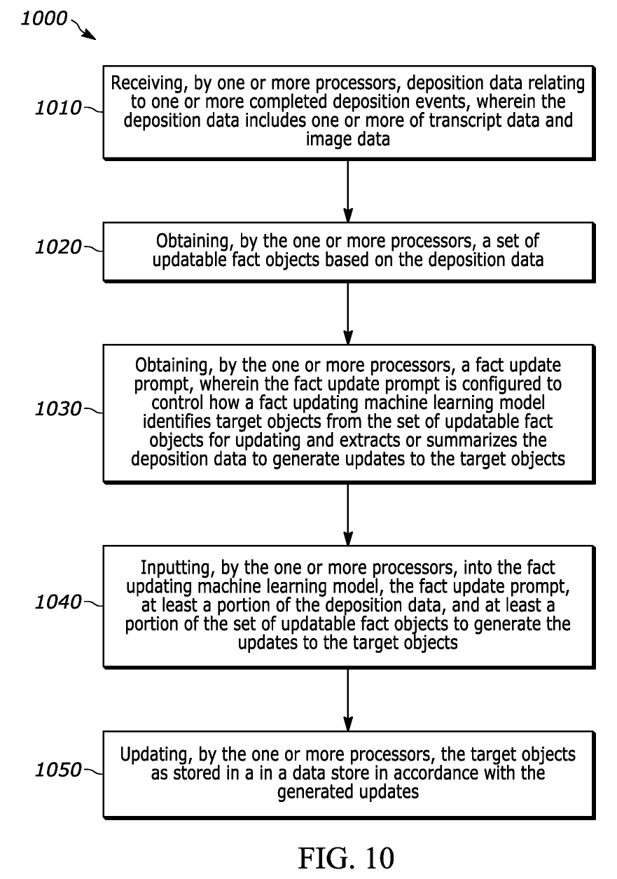

FIG. 10 shows a computer-implemented method 1000 for using the fact updating ML model 902 to generate the updates 908. The method 1000 may be performed by the processing unit 104 executing instructions stored on the memory unit 106 to support the various modules described herein that are executed within the workspace 102.

At block 1010, the method 1000 includes receiving, by one or more processors, deposition data (e.g., deposition data 110) relating to one or more completed deposition events. The deposition data may include one or more of transcript data and image data.

At block 1020, the method 1000 includes obtaining, by the one or more processors, a set of updatable fact objects (e.g., updatable fact objects 906) based on the deposition data.

To obtain the set of updatable fact objects based on the deposition data, the method 1000 may include generating one or more search queries based on the deposition data; query the data store using the one or more search queries and defining the set of updatable fact objects based on results of the query. Additionally or alternatively, to obtain the set of updatable fact objects based on the deposition data, the method 1000 may include obtaining a set of keywords or phrases that are associated with respective ones of the fact objects stored in the data store, parsing the deposition data to identify matched keywords or phrases from the set of keywords or phrases that at least semantically match one or more portions of the deposition data and defining the set of updatable fact objects as the fact objects associated with the matched keywords or phrases.

At block 1030, the method 1000 includes obtaining, by the one or more processors, a fact update prompt. The fact update prompt is configured to control how a fact updating machine learning model (e.g., fact updating ML model 902) (i) identifies target objects from the set of updatable fact objects for updating and (ii) extracts or summarizes the deposition data to generate updates to the target objects.

At block 1040, the method 1000 includes inputting, by the one or more processors and into the fact updating machine learning model, the fact update prompt, at least a portion of the deposition data, and at least a portion of the set of updatable fact objects to generate the updates (e.g., updates 908) to the target objects.

At block 1050, the method 1000 includes updating, by the one or more processors, the target objects as stored in a data store (e.g., data store 120) in accordance with the generated updates. Updating the target objects may include identifying, within the data store, data fields of the target objects associated with the generated updates and modifying the identified data fields in accordance with the generated updates.

In some embodiments, during a deposition event, a deposition analysis machine learning model (e.g., deposition analysis ML model 108) is configured to live analyze the deposition data as the deposition data is being generated to generate identifiers identifying one or more fact objects, maintained in a cache (e.g., cache 420) of a client device (e.g., client device 122), as related to the deposition data. In these embodiments, obtaining the set of updatable fact objects includes obtaining the set of updatable fact objects from the data store based on the identifiers.

In some embodiments, during a deposition event, a deposition analysis machine learning model is configured to live analyze the deposition data as the deposition data is being generated and flag one or more fact objects maintained in a cache of a client device as related to the deposition data. In these embodiments, obtaining the set of updatable fact objects based on the deposition data includes obtaining flagged one or more fact objects from the cache of the client device and defining the flagged one or more fact objects as the set of updatable fact objects.

In some embodiments, during a deposition event, a deposition analysis machine learning model is configured to live analyze the deposition data as the deposition data is being generated to perform at least one of: updating one or more fact objects maintained in a cache of a client device based on the deposition data and generating one or more new fact objects for storage in the cache of the client device. The one or more fact objects maintained in the cache of the client device may include copies of one or more fact objects stored in the data store. In these embodiments, the method 1000 may include excluding the copies of the updated one or more fact objects from the set of updatable fact objects, replacing the copies of the updated one or more fact objects stored in the data store with the updated one or more fact objects maintained in the cache of the client device, and storing the one or more new fact objects in the data store.

In some embodiments, obtaining the set of updatable fact objects based on the deposition data includes identifying segmentation markers present in the deposition data, segmenting portions of the deposition data into segmented text portions, and associating respective sets of the updatable fact objects with the segmented text portions. In these embodiments, generating the updates to the target objects includes inputting, into the fact updating machine learning model, at least one segmented text portion as the portion of the deposition data and the associated ones of the respective sets of the updatable fact objects as the portion of the set of updatable fact objects. The segmentation markers may include one or more of a change in speaker or a time pause between portions of the deposition data that exceeds a preconfigured threshold. The segmentation markers may include one or more topic identifiers that delineate one or more portions of the deposition data that relate to a common theme or objective.

The fact update prompt may include instructions that direct the fact updating machine learning model to compare text of the deposition data to text of the set of updatable fact objects, identify relevant portions of the deposition data that supplement or contradict portions the set of updatable fact objects, and generate the updates based on the relevant portions of the deposition data. The generated updates may include replacement text for the portions of the target objects, the replacement text including a summary of the relevant portions of the deposition data and the portions of the target objects; and updating the target objects may include replacing portions of the target objects with the generated updates. The generated updates may include additional text for the target objects. The additional text may include a summary of the relevant portions of the deposition data and updating the target objects may include appending the generated updates to portions of the target objects.

In some embodiments, the method 1000 includes populating, by the one or more processors, respective data fields of one or more new fact objects based upon new facts generated by the fact updating machine learning model. The fact update prompt may include instructions that direct the fact updating machine learning model to compare the deposition data to text of the set of updatable fact objects to identify first portions of the deposition data that at least semantically match text in the set of updatable fact objects and second portions of the deposition data that (1) comprise an identified fact and (2) fail to at least semantically match text in the set of updatable fact objects; and generate the new facts based on the second portions of the deposition data.

In some embodiments during a deposition event, a deposition analysis machine learning model is configured to live analyze the deposition data as the deposition data is being generated, determine veracity of portions of the deposition data relative to one or more fact objects stored in a cache of a client device, and store a record of the veracity determinations in the cache. In these embodiments, the record may be input into the fact updating machine learning model with the fact update prompt, the deposition data, and the set of updatable fact objects; and the fact update prompt may include instructions that direct the fact updating machine learning model to compare the veracity determinations in the record to the set of updatable fact objects to identify incorrect veracity determinations that are contradicted by the set of updatable fact objects. In these embodiments, the method 1000 may include tuning parameters of the deposition analysis machine learning model based on the identified incorrect veracity determinations.

### OTHER MATTERS

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘_______’ is hereby defined to mean…” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A computer system comprising:
one or more processors; and
one or more non-transitory, computer-readable media storing instructions that, when executed by the one or more processors, cause the computer system to:
receive deposition data relating to one or more completed deposition events, wherein the deposition data includes one or more of transcript data and image data;
obtain a set of updatable fact objects based on the deposition data;
obtain a fact update prompt, wherein the fact update prompt is configured to control how a fact updating machine learning model (i) identifies target objects from the set of updatable fact objects for updating and (ii) extracts or summarizes the deposition data to generate updates to the target objects;
input, into the fact updating machine learning model, the fact update prompt, at least a portion of the deposition data, and at least a portion of the set of updatable fact objects to generate the updates to the target objects; and
update the target objects as stored in a data store in accordance with the generated updates.

2. The computer system of claim 1, wherein to obtain the set of updatable fact objects based on the deposition data, the instructions, when executed by the one or more processors, cause the computer system to:
generate one or more search queries based on the deposition data;
query the data store using the one or more search queries; and
define the set of updatable fact objects based on results of the query.

3. The computer system of claim 1, wherein to obtain the set of updatable fact objects based on the deposition data, the instructions, when executed by the one or more processors, cause the computer system to:
obtain a set of keywords or phrases that are associated with respective ones of the fact objects stored in the data store;
parse the deposition data to identify matched keywords or phrases from the set of keywords or phrases that at least semantically match one or more portions of the deposition data; and
define the set of updatable fact objects as the fact objects associated with the matched keywords or phrases.

4. The computer system of claim 1, wherein:
during a deposition event, a deposition analysis machine learning model is configured to live analyze the deposition data as the deposition data is being generated to generate identifiers identifying one or more fact objects, maintained in a cache of a client device, as related to the deposition data; and
to obtain the set of updatable fact objects, the instructions, when executed by the one or more processors, cause the computer system to:
obtain the set of updatable fact objects from the data store based on the identifiers.

5. The computer system of claim 1, wherein:
during a deposition event, a deposition analysis machine learning model is configured to live analyze the deposition data as the deposition data is being generated and flag one or more fact objects maintained in a cache of a client device as related to the deposition data; and
to obtain the set of updatable fact objects based on the deposition data, the instructions, when executed by the one or more processors, cause the computer system to:
obtain flagged one or more fact objects from the cache of the client device; and
define the flagged one or more fact objects as the set of updatable fact objects.

6. The computer system of claim 1, wherein:
during a deposition event, a deposition analysis machine learning model is configured to live analyze the deposition data as the deposition data is being generated to perform at least one of:
updating one or more fact objects maintained in a cache of a client device based on the deposition data, wherein the one or more fact objects maintained in the cache of the client device are copies of one or more fact objects stored in the data store, and
generating one or more new fact objects for storage in the cache of the client device; and
the instructions, when executed by the one or more processors, cause the computer system to:
exclude the copies of the updated one or more fact objects from the set of updatable fact objects;
replace the copies of the updated one or more fact objects stored in the data store with the updated one or more fact objects maintained in the cache of the client device; and
store the one or more new fact objects in the data store.

7. The computer system of claim 1, wherein:
to obtain the set of updatable fact objects based on the deposition data, the instructions, when executed by the one or more processors, cause the computer system to:
identify segmentation markers present in the deposition data,
segment portions of the deposition data into segmented text portions, and
associate respective sets of the updatable fact objects with the segmented text portions; and
to generate the updates to the target objects, the instructions, when executed by the one or more processors, cause the computer system to:
input, into the fact updating machine learning model, at least one segmented text portion as the portion of the deposition data and the associated respective sets of the updatable fact objects as the portion of the set of updatable fact objects.

8. The computer system of claim 7, wherein the segmentation markers include one or more of a change in speaker or a time pause between portions of the deposition data that exceeds a preconfigured threshold.

9. The computer system of claim 7, wherein the segmentation markers include one or more topic identifiers that delineate one or more portions of the deposition data that relate to a common theme or objective.

10. The computer system of claim 1, wherein the fact update prompt includes instructions that direct the fact updating machine learning model to:
compare text of the deposition data to text of the set of updatable fact objects,
identify relevant portions of the deposition data that supplement or contradict portions the set of updatable fact objects; and
generate the updates based on the relevant portions of the deposition data.

11. The computer system of claim 10, wherein:
the generated updates include replacement text for the portions of the target objects, the replacement text including a summary of the relevant portions of the deposition data and the portions of the target objects; and
to update the target objects, the instructions, when executed by the one or more processors, cause the computer system to replace portions of the target objects with the generated updates.

12. The computer system of claim 10, wherein:
the generated updates include additional text for the target objects, the additional text including a summary of the relevant portions of the deposition data; and
to update the target objects, the instructions, when executed by the one or more processors, cause the computer system to append the generated updates to portions of the target objects.

13. The computer system of claim 1, wherein:
the instructions, when executed by the one or more processors, cause the computer system to populate respective data fields of one or more new fact objects based upon new facts generated by the fact updating machine learning model; and
the fact update prompt includes instructions that direct the fact updating machine learning model to:
compare the deposition data to text of the set of updatable fact objects to identify first portions of the deposition data that at least semantically match text in the set of updatable fact objects and second portions of the deposition data that (1) comprise an identified fact and (2) fail to at least semantically match text in the set of updatable fact objects; and
generate the new facts based on the second portions of the deposition data.

14. The computer system of claim 1, wherein:
during a deposition event, a deposition analysis machine learning model is configured to live analyze the deposition data as the deposition data is being generated, determine veracity of portions of the deposition data relative to one or more fact objects stored in a cache of a client device, and store a record of the veracity determinations in the cache;
the record is input into the fact updating machine learning model with the fact update prompt, the deposition data, and the set of updatable fact objects; and
the fact update prompt includes instructions that direct the fact updating machine learning model to:
compare the veracity determinations in the record to the set of updatable fact objects to identify incorrect veracity determinations that are contradicted by the set of updatable fact objects.

15. The computer system of claim 14, wherein the instructions, when executed by the one or more processors, cause the computer system to:
tune parameters of deposition analysis machine learning model based on the identified incorrect veracity determinations.

16. The computer system of claim 1, wherein to update the target objects the instructions, when executed by the one or more processors, cause the computer system to:
identify, within the data store, data fields of the target objects associated with the generated updates; and
modify the identified data fields in accordance with the generated updates.

17. A computer-implemented method for generating updates for fact objects, the method comprising:
receiving, by one or more processors, deposition data relating to one or more completed deposition events, wherein the deposition data includes one or more of transcript data and image data;
obtaining, by the one or more processors, a set of updatable fact objects based on the deposition data;
obtaining, by the one or more processors, a fact update prompt, wherein the fact update prompt is configured to control how a fact updating machine learning model (i) identifies target objects from the set of updatable fact objects for updating and (ii) extracts or summarizes the deposition data to generate updates to the target objects;
inputting, by the one or more processors and into the fact updating machine learning model, the fact update prompt, at least a portion of the deposition data, and at least a portion of the set of updatable fact objects to generate the updates to the target objects; and
updating, by the one or more processors, the target objects as stored in a data store in accordance with the generated updates.

18. The computer-implemented method of claim 17, wherein the fact update prompt includes instructions that direct the fact updating machine learning model to:
compare text of the deposition data to text of the set of updatable fact objects,
identify relevant portions of the deposition data that supplement or contradict portions the set of updatable fact objects; and
generate the updates based on the relevant portions of the deposition data.

19. The computer-implemented method of claim 17, further comprising:
Populating, by the one or more processors, respective data fields of one or more new fact objects based upon new facts generated by the fact updating machine learning model,
wherein, the fact update prompt includes instructions that direct the fact updating machine learning model to:
compare the deposition data to text of the set of updatable fact objects to identify first portions of the deposition data that at least semantically match text in the set of updatable fact objects and second portions of the deposition data that (1) comprise an identified fact and (2) fail to at least semantically match text in the set of updatable fact objects; and
generate the new facts based on the second portions of the deposition data.

20. A non-transitory machine-readable medium comprising a plurality of machine-readable instructions that when executed by one or more processors are adapted to cause the one or more processors to:
receive deposition data relating to one or more completed deposition events, wherein the deposition data includes one or more of transcript data and image data;
obtain a set of updatable fact objects based on the deposition data;
obtain a fact update prompt, wherein the fact update prompt is configured to control how a fact updating machine learning model (i) identifies target objects from the set of updatable fact objects for updating and (ii) extracts or summarizes the deposition data to generate updates to the target objects;
input, into the fact updating machine learning model, the fact update prompt, at least a portion of the deposition data, and at least a portion of the set of updatable fact objects to generate the updates to the target objects; and
update the target objects as stored in a data store in accordance with the generated updates.
